(19) United States
(12) Patent Application Publication
(10) Pub. No.: US 2025/0183581 A1
(43) Pub. Date: Jun. 5, 2025

(54) RELIABLE HIGH SPEED CONNECTOR WITH INTEGRATED POWER

(71) Applicant: Amphenol East Asia Electronic Technology (Shenzhen) Co., Ltd., Shenzhen (CN)

(72) Inventors: Danren He, Shenzhen (CN); Qiang Leng, Shenzhen (CN); Qing Hong, Shenzhen (CN)

(73) Assignee: Amphenol East Asia Electronic Technology (Shenzhen) Co., Ltd., Shenzhen (CN)

(21) Appl. No.: 18/967,586

(22) Filed: Dec. 3, 2024

(30) Foreign Application Priority Data
Dec. 5, 2023 (CN) 202311665802.X
Dec. 5, 2023 (CN) 202323319783.3

(51) Int. Cl. H01R 13/502; H01R 12/71; H01R 13/52; H01R 13/627; H01R 13/639; H01R 13/641

(52) U.S. Cl. CPC H01R 13/502; H01R 13/5202; H01R 13/6272; H01R 13/639; H01R 13/641; H01R 12/716

(57) ABSTRACT

Reliable high speed connectors with integrated power. The connectors can be connected to both provide high signal integrity and supply reliable power in a harsh environment, such as an automobile. A connector can include a housing comprising a front portion, a rear portion, a subassembly chamber for receiving a terminal subassembly, and multiple terminal channels each for receiving an individual terminal. The terminal subassembly comprises a pair of terminals configured for transmitting high-speed signals. The individual terminals are configured for transmitting power signals and/or low-speed signals. When the connector is a plug, the front portion of the housing comprise position assurance features configured to restrain movements of the individual terminals in respective terminal channels. A seal can be disposed closer to the position assurance features than the rear portion. When the connector is a receptacle, the rear portion of the housing comprise a flange facing an inner side of a panel. A seal can be disposed between the panel and the flange.

### CROSS-REFERENCE TO RELATED APPLICATIONS

This application claims priority to and the benefit of Chinese Patent Application No. 202323319783.3, filed on Dec. 5, 2023. This application also claims priority to and the benefit of Chinese Patent Application No. 202311665802.X, filed on Dec. 5, 2023. The contents of these applications are incorporated herein by reference in their entirety.

### TECHNICAL FIELD

This patent application relates generally to interconnection systems, such as those including electrical connectors, used to interconnect electronic assemblies, and more specifically to electrical connectors for harsh environments, such as in a vehicle.

### BACKGROUND

Electrical connectors are used in many electronic systems. It is generally easier and more cost effective to manufacture an electronic system as separate electronic assemblies, which may be joined together with electrical connectors. Electrical connectors may be used for interconnecting assemblies so that the assemblies may operate together as part of an electronic system. Electrical connectors, for example, may be mounted on printed circuit boards within two assemblies that are connected by mating the electrical connectors. In other electronic systems, it may be impractical to join two printed circuit boards by directly mating electrical connectors on those printed circuit boards. For example, when the electronic system is assembled, those printed circuit boards may be separated by too great a distance for a direct connection between electrical connectors mounted in the printed circuit boards.

In some electronic systems, connections between assemblies may be made through cables. The cables may be terminated with connectors that mate with connectors mounted on a printed circuit board. In this way, connections between assemblies may be made by plugging an electrical connector that is part of cable assembly into an electrical connector that is mounted to printed circuit board. In other electronic system architectures, an electrical connector terminating a cable may be mated with another electrical connector terminating another cable.

An example of an electronic system in which assemblies are connected through cables is a modern automobile. For example, automotive vehicles include electronic control units (ECUs) for controlling various vehicle systems, such as the engines, transmissions (TCUs), security systems, emissions control, lighting, advanced driver assistance systems (ADASs), entertainment systems, navigation systems, and cameras. The ECUs may be manufactured as separate assemblies and connected over one or more vehicle networks formed with cables routed between these assemblies. To simplify manufacture of an automobile, the assemblies may be formed separately and then connected via cables that are terminated with electrical connectors that enable connections to mating electrical connectors terminating other cables or attached to printed circuit boards within the assemblies.

An automobile presents a harsh environment for an electrical connector. The automobile may vibrate, which can cause a connector to unmate and cease working entirely. Even if the vibration does not completely prevent operation of the connector, it can cause electrical noise, which can interfere with operation of electronics joined through interconnects including connectors. Noise, for example, may result from relative movement of components within connectors, which can change the electrical properties of the connector. Variations in the electrical properties, in turn, cause variation in the signals passing through the interconnect, which is a form of noise that interferes with processing the underlying signal.

In an automotive environment, electrical noise might also arise from automotive components that generate electromagnetic radiation. That radiation can couple to the conductive structures of a connector, creating noise on any signals passing over those conductive structures.

In an automobile, any of a number of components might generate electromagnetic radiation, such as spark plugs, alternators or power switches. Noise can be particularly disruptive for high speed signals such as those used to communicate data over an automobile network.

### SUMMARY

Aspects of the disclosure relate to reliable high speed connectors with integrated power.

Some embodiments relate to an electrical connector. The electrical connector may include a housing comprising a front portion, a rear portion, a subassembly chamber, and a plurality of terminal channels; a terminal subassembly disposed in the subassembly chamber, the terminal subassembly comprising a pair of terminals configured for transmitting high-speed signals; and a plurality of terminals, each of the plurality of terminals disposed in one of the plurality of terminal channels, the plurality of terminals configured for transmitting power signals and/or low-speed signals.

Optionally, both the subassembly chamber and the plurality of terminal channels extend from the front portion to the rear portion; and each of the plurality of terminals comprises a beam configured to extend into a top wall of the front portion of the housing so as to restrain movements of the terminal.

Optionally, the housing comprises a latch having a cantilever, and a supporting feature protruding from an outer surface; the electrical connector further comprises a connector position assurance device, the connector position assurance device is movably mounted to the latch of the housing between a locked position and an unlocked position; and the connector position assurance device comprises a main body configured to be disposed above the supporting feature when the connector position assurance device is in the locked position, and a cantilever extending from the main body and configured to abut against an outer side of the cantilever of the latch of the housing when the connector position assurance device is in the locked position.

Optionally, the housing is an inner housing; and the electrical connector further comprises an outer housing disposed outside the inner housing and comprising a cover protruding above the cantilever of the latch of the inner housing.

Optionally, the front portion of the housing has an asymmetric contour in a lateral plane perpendicular to a mating direction.

Optionally, the plurality of terminals are arranged in a plurality of rows; and the electrical connector further comprises a terminal position assurance device configured to restrain movements of the plurality of terminals.

Optionally, the front portion of the housing comprises an annular recess encircling the front portion in a circumferential direction perpendicular to a mating direction; and the electrical connector comprises a mating end seal disposed in the annular recess, and a tail end seal disposed in the rear portion of the housing and configured for cables passing therethrough.

Optionally, the front portion of the housing comprises a front end, a rear end disposed opposite each other in a mating direction, and a single front opening extending from the front end to the rear end; and the rear portion of the housing is connected to the rear end of the front portion of the housing, the rear portion comprising the subassembly chamber and the plurality of terminal channels.

Optionally, the rear portion of the housing comprises a flange protruding from an outer sidewall, and a surface facing the front portion of the housing and a recess from the surface; and the electrical connector further comprises a panel seal disposed on the flange and having a tab disposed in the recess.

Some embodiments relate to an electrical connector. The electrical connector may include a housing comprising a front portion, a rear portion, and a plurality of terminal channels extending from the front portion to the rear portion; a plurality of terminals, each of the plurality of terminals disposed in one of the plurality of terminal channels and comprising a mating end disposed in the front portion of the housing and a tail end disposed in the rear portion of the housing. The front portion of the housing may comprise one or more position assurance features configured to restrain movements of each of the plurality of terminals in the respective terminal channel.

Optionally, the one or more position assurance features comprise a plurality of slits extending through an inner surface of the housing to an outer surface of the housing; the plurality of slits are disposed in a one-to-one correspondence with the plurality of terminals; and the mating end of each of the plurality of terminals comprises a beam extending into a respective slit of the plurality of slits.

Optionally, the housing comprises a locking slot extending in a first lateral direction perpendicular to a mating direction of the electrical connector; the one or more position assurance features comprise the locking slot and a terminal position assurance device; the locking slot comprises a first locking slot sidewall and a second locking slot sidewall opposite each other in the mating direction, the first locking slot sidewall comprising a guiding groove, and the second locking slot sidewall comprising a notch; and the terminal position assurance device comprises a first side and a second side opposite each other in the mating direction, the first side comprising a guiding feature inserted into the guiding groove of the locking slot, and the second side comprising a barb engaged with the notch of the locking slot.

Optionally, the terminal position assurance device is configured to mounted into the locking slot of the housing in the first lateral direction.

Optionally, the plurality of terminals are arranged in two rows spaced apart from each other in a second lateral direction perpendicular to the first lateral direction and the mating direction; the terminal position assurance device comprises a first arm and a second arm connected to the first arm; and the first and second arms of the terminal position assurance device are configured to restrain movements of the terminals in the two rows, respectively.

Optionally, the terminal position assurance device comprises a body having an inner surface, a projection extending from the inner surface and configured to restrain movements of the plurality of terminals in the mating direction.

Optionally, the electrical connector further comprises a seal disposed closer to the front portion of the housing than the rear portion of the housing and encircling the front portion of the housing in a circumferential direction perpendicular to the mating direction.

Some embodiments relate to an electronic system. The electronic system may comprise a panel comprising an opening; and an electrical connector. The electrical connector may comprise a housing comprising a front portion extending through the opening to an outer side of the panel, and a rear portion connected to the front portion and disposed on an inner side of the panel, the rear portion of the housing comprising a flange protruding from an outer sidewall and having a surface facing the panel, and a seal disposed between the panel and the surface of the flange facing the panel.

Optionally, the rear portion of the housing comprises a subassembly chamber configured to receive a terminal subassembly, and a plurality of terminal channels each configured to receive a terminal.

Optionally, the flange opposite comprises a post extending toward the inner side of the panel; and the post comprises a hole extending to the surface facing the panel and configured to receive a fastener for securing the flange to the panel.

Optionally, the rear portion of the housing comprises a plurality of recesses; and the seal comprises a plurality of tabs protruding inwardly and disposed in a respective one of the plurality of recesses.

Some embodiments relate to an electrical connector. The electrical connecter may comprise an inner housing, a plurality of first terminals and a terminal subassembly. The inner housing may have a front portion and a rear portion. The inner housing may comprise a subassembly chamber and a plurality of terminal channels extending from the front portion to the rear portion. The plurality of first terminals may be disposed in the plurality of terminal channels in a one-to-one correspondence. The plurality of first terminals may be configured for transmitting power signals and/or low-speed signals. The terminal subassembly may be disposed in the subassembly chamber.

Optionally, the plurality of first terminals may be disposed in the plurality of terminal channels from the rear portion. The inner housing may be provided with a slit. Each of the plurality of first terminals may be provided with a third beam engaged with the slit. The slit may block the third beam in a direction toward the rear portion.

Optionally, there may be a plurality of the slits disposed in a one-to-one correspondence with the plurality of first terminals.

Optionally, the slit may penetrate from an inner surface to an outer surface of the inner housing.

Optionally, each of the plurality of first terminals may have a mating end configured for electrically contacting with a mating electrical connector. The slit may be positioned corresponding to the mating end.

Optionally, an outer surface of the inner housing may be provided with a housing latch including a cantilever. A gap may be provided between the cantilever and the outer surface of the inner housing for receiving a portion of a mating electrical connector configured to engage with the cantilever. The electrical connector may further comprise a connector position assurance device. The connector position assurance device may be movably mounted to the inner housing between a locked position and an unlocked position in a mating direction of the front portion with the mating electrical connector. The connector position assurance device may include a main body and a cantilever connected to the main body. The cantilever of the connector position assurance device may abut against the cantilever of the housing latch on an outer side of the cantilever of the housing latch opposite the gap when the connector position assurance device is in the locked position. The cantilever may release the cantilever when the connector position assurance device is in the unlocked position.

Optionally, the electrical connector may further comprise an outer housing sleeved on the inner housing. The outer housing may comprise a protruding cover configured to enclose the cantilever of the housing latch.

Optionally, the outer housing may have a front end and a rear end disposed opposite each other in the mating direction of the front portion with the mating electrical connector. The front end and the front portion may be oriented the same direction. The outer housing may have a housing opening exposing the connector position assurance device and the housing latch. The housing opening may extend to the front end. The cover may include a first cover sidewall, a second cover sidewall and a top wall. The first cover sidewall and the second cover sidewall may extend outwardly from two sides of the housing opening opposite each other in a first lateral direction perpendicular to the mating direction, respectively. The top wall may be connected between the first cover sidewall and the second cover sidewall.

Optionally, the main body may be exposed by the cover and the cantilever of the housing latch may be shielded by the cover.

Optionally, the first cover sidewall and the second cover sidewall may extend from the top wall in a direction from the front end to the rear end.

Optionally, the top wall, the first cover sidewall and the second cover sidewall may extend to the front end.

Optionally, the first cover sidewall and the second cover sidewall may extend to an end face of the main body opposed to the cantilever of the housing latch.

Optionally, the outer surface of the inner housing may be provided with a supporting feature. The main body of the connector position assurance device may abut against the supporting feature in a direction perpendicular to the outer surface when the connector position assurance device is in the locked position.

Optionally, the housing latch may be provided with a first guiding groove extending in the mating direction. The main body of the connector position assurance device may be slidably connected to the first guiding groove.

Optionally, the front portion may have an asymmetric contour in a lateral plane perpendicular to a mating direction of the front portion with a mating electrical connector.

Optionally, the front portion may have a first corner and a second corner disposed opposite each other in a first lateral direction perpendicular to the mating direction. Outer surfaces of the first corner and the second corner both may be inclined. The outer surface of the first corner may be provided with a rib extending in the mating direction.

Optionally, the electrical connector may further comprise a terminal position assurance device mounted to the inner housing in a first lateral direction perpendicular to a mating direction of the front portion with a mating electrical connector. The terminal position assurance device may be configured for assuring the position of the plurality of first terminals in the mating direction.

Optionally, the plurality of first terminals may be arranged in two rows spaced apart from each other in a second lateral direction perpendicular to the first lateral direction and the mating direction.

Optionally, the terminal position assurance device may include a first arm and a second arm. The first arm and the second arm may be connected with each other such that the terminal position assurance device is U-shaped. The first arm and the second arm may lock the two rows, respectively.

Optionally, the inner housing may be provided with a locking slot extending in the first lateral direction. The locking slot may have a first locking slot sidewall and a second locking slot sidewall disposed opposite each other in the mating direction. The first locking slot sidewall may be provided with a second guiding groove. The second locking slot sidewall may be provided with a notch. The terminal position assurance device may have a first side and a second side disposed opposite each other in the mating direction. The first side may be provided with a guiding feature inserted into the second guiding groove. The second side may be provided with a barb engaged with the notch.

Optionally, the terminal position assurance device may be provided with a slit extending in the first lateral direction. A distance from the slit to the first side may be greater than a distance to the second side. The barb may be at a position corresponding to a middle of the slit.

Optionally, the terminal position assurance device may include a body having an inner surface facing an interior of the inner housing. The inner surface may be provided with a projection extending in the first lateral direction. The projection may block the plurality of first terminals in a direction toward the rear portion.

Optionally, the body may span the plurality of first terminals in the first lateral direction. The projection may extend from the body in the first lateral direction and a protruding end of the projection may extend into the inner housing.

Optionally, the terminal position assurance device may have a first side and a second side disposed opposite each other in the mating direction. The projection may be flush with the body at the first side. The inner housing may be provided with a guiding groove extending in the first lateral direction. The first side may be provided with a guiding feature inserted in the guiding groove.

Optionally, the guiding feature may be flush with an inner surface of the projection. The guiding feature may be spaced apart from an outer surface of the body.

Optionally, the front portion of the inner housing may be provided with an annular recess on an outer surface thereof. The annular recess may encircle the front portion in a circumferential direction perpendicular to a mating direction of the front portion with a mating electrical connector. The annular recess may be configured to receive a mating end seal configured for sealing between the front portion and the mating electrical connector.

Optionally, the electrical connector may further comprise a tail end seal disposed in the rear portion of the inner housing. A first cable terminated to the terminal subassembly and second cables terminated to the plurality of first terminals may pass through the tail end seal.

Some embodiments relate to a cable connector. The cable connector may comprise an inner housing, a plurality of first terminals and a position assurance feature. The inner housing may have a front portion and a rear portion. The inner housing may comprise a plurality of terminal channels extending from the front portion to the rear portion. The plurality of first terminals may be disposed in the plurality of terminal channels in a one-to-one correspondence. The plurality of first terminals may be configured for transmitting power signals and/or low-speed signals. The position assurance feature may be configured to restrain the movement of the plurality of first terminals in a mating direction of the front portion with a mating electrical connector.

Optionally, the plurality of first terminals may be disposed in the plurality of terminal channels from the rear portion. Each of the plurality of first terminals may have a mating end for electrically contacting with the mating electrical connector. The mating end may abut against the front portion of the inner housing. The position assurance feature may be configured to restrain the plurality of first terminals in a direction toward the rear portion.

Optionally, the position assurance feature may include a slit disposed in the inner housing. Each of the plurality of first terminals may be provided with a third beam engaged with the slit.

Optionally, the slit may penetrate an inner surface of the inner housing to an outer surface. Optionally, there may be a plurality of the slits disposed in a one-to-one correspondence with the plurality of first terminals. Optionally, the slit may correspond to the mating end in position.

Optionally, the position assurance feature may include a terminal position assurance device mounted to the inner housing in a first lateral direction perpendicular to the mating direction.

Optionally, the plurality of first terminals may be arranged in two rows spaced apart from each other in a second lateral direction perpendicular to the first lateral direction and the mating direction.

Optionally, the terminal position assurance device may include a first arm and a second arm. The first arm and the second arm may be connected to each other such that the terminal position assurance device is U-shaped. The first arm and the second arm may lock the two rows, respectively.

Optionally, the inner housing may be provided with a locking slot extending in the first lateral direction. The locking slot may have a first locking slot sidewall and a second locking slot sidewall opposite each other in the mating direction. The first locking slot sidewall may be provided with a guiding groove. The second locking slot sidewall may be provided with a notch. The terminal position assurance device may have a first side and a second side disposed opposite each other in the mating direction. The first side may be provided with a guiding feature inserted into the guiding groove. The second side may be provided with a barb engaged with the notch.

Optionally, the terminal position assurance device may include a body having an inner surface facing an interior of the inner housing. The inner surface may be provided with a projection extending in the first lateral direction. The projection may block the plurality of first terminals in a direction toward the rear portion.

Optionally, the body may span the plurality of first terminals in the first lateral direction. The projection may extend from the body in the first lateral direction. A protruding end of projection may extend into the inner housing.

Optionally, the terminal position assurance device may have a first side and a second side disposed opposite each other in the mating direction. The projection may be flush with the body at the first side. The inner housing may be provided with a guiding groove extending in the first lateral direction. The first side may be provided with a guiding feature inserted in the guiding groove.

Optionally, the guiding feature may be flush with an inner surface of the projection, and be spaced apart from an outer surface of the body.

Some embodiments relate to a board connector. The board connector may comprise a housing, a plurality of second terminals and a terminal subassembly. The housing may include a front portion and a rear portion. The front portion may have a front end and a rear end disposed opposite each other in a mating direction. The front portion may be provided with a single front opening. The front opening may extend from the front end to the rear end. The rear portion may be connected to the rear end. The rear portion may have a subassembly chamber and a plurality of terminal channels aligned with the front opening. The plurality of second terminals may be disposed in the plurality of terminal channels in a one-to-one correspondence. The terminal subassembly be disposed in the subassembly chamber.

Optionally, the board connector may further comprise a flange protruding from an outer sidewall of the rear portion in a lateral direction. The flange may be provided with a hole.

Optionally, the board connector may further comprise a panel seal encircling the front portion. The panel seal may be fixed to a surface of the flange facing the mating end in the mating direction.

Optionally, the panel seal may be provided with a tab protruding in a lateral direction. The flange may be provided with a recess, and the tab may be disposed in the recess.

Some embodiments relate to an electronic system. The electronic system may comprise a board connector and a panel. The panel may be provided with an opening. The board connector may be fixed to the panel by a fastener. The board connector may comprise a housing, a plurality of second terminals and a terminal subassembly. A front portion of the housing may extend to an outer side of the panel through the opening. The housing may have a plurality of terminal channels and a subassembly chamber. The plurality of second terminals may be disposed in the plurality of terminal channels in a one-to-one correspondence and extend into the front portion. The terminal subassembly may be mounted to the subassembly chamber and extend into the front portion.

Optionally, the board connector may further comprise a flange protruding in a lateral direction from an outer sidewall of the housing. A first surface of the flange may abut against an inner surface of the panel.

Optionally, the fastener may secure the flange to the panel.

Optionally, a second surface of the flange opposite the first surface may be provided with a post extending toward an inner side of the panel. The post may be provided with a hole penetrating to the first surface. The hole may be accommodated with a nut connected with the fastener.

Optionally, a reinforcing rib may be connected among the post, the outer sidewall of the housing and the flange.

Optionally, the board connector may further comprise a panel seal encircling the housing and clamped between the housing and the inner surface of the panel.

Optionally, the panel seal may be provided with a hole with the fastener passing therethrough.

Optionally, the panel seal may be provided with a tab protruding in a lateral direction. The housing may be provided with a recess, and the tab may be disposed in the recess.

These techniques may be used alone or in any suitable combination. The foregoing summary is provided by way of illustration and is not intended to be limiting.

### BRIEF DESCRIPTION OF THE DRAWINGS

The accompanying drawings may not be drawn to scale. In the drawings, each identical or nearly identical component that is illustrated in various figures may be represented by a like numeral. For purposes of clarity, not every component may be labeled in every drawing. In the drawings:

FIG. 1 is a top, side perspective view of an electronic system comprising a cable connector and a vertical board connector, according to a first exemplary embodiment of the present disclosure.

FIG. 2 is a top, side perspective view of the electronic system of FIG. 1, with a circuit board hidden and showing tail ends of the vertical board connector.

FIG. 3 is a perspective view of the electronic system of FIG. 2, showing the vertical board connector attached to a panel and the cable connector is about to mate with the vertical board connector.

FIG. 4 is a cross-sectional view of the electronic system of FIG. 2 along a plane orthogonal to a mating direction of the connectors.

FIG. 5 is a top, rear perspective view of the cable connector of FIG. 1.

FIG. 6 is a top, front perspective view of the cable connector of FIG. 5.

FIG. 7 is a top, side perspective view of the cable connector of FIG. 5, with an outer housing hidden.

FIG. 8 is a side perspective view of the cable connector of FIG. 7.

FIG. 9 is a bottom, front perspective view of the cable connector of FIG. 7.

FIG. 10 is a cross-sectional view of the cable connector of FIG. 7 along a plane orthogonal to the mating direction of the connectors and between a subassembly chamber and terminal channels.

FIG. 11 is a cross-sectional view of the cable connector of FIG. 7 along another plane orthogonal to the mating direction of the connectors and showing terminal channels.

FIG. 12 is a side perspective view of an inner housing of the cable connector of FIG. 5.

FIG. 13 is a front, side perspective view of the inner housing of FIG. 12.

FIG. 14 is a bottom, front perspective view of the inner housing of FIG. 12.

FIG. 15 is a perspective view of a connector position assurance device of the cable connector of FIG. 5.

FIG. 16a is a perspective view of a terminal position assurance device of the cable connector of FIG. 6 at an angle.

FIG. 16b is a perspective view of a terminal position assurance device of FIG. 16a at another angle.

FIG. 17 is a partially enlarged view of first terminals of the electrical connector of FIG. 5.

FIG. 18 is a perspective view of the outer housing of the cable connector of FIG. 5.

FIG. 19 is a perspective view of the electronic system in FIG. 2, with the cable connector hidden, showing a front of the vertical board connector.

FIG. 20 is a perspective view of the electronic system of FIG. 19, showing a rear of the vertical board connector.

FIG. 21 is a cross-sectional view of the electronic system of FIG. 19 along a plane orthogonal to the mating direction of the connectors and showing a subassembly chamber.

FIG. 22a is an exploded view of the electronic system of FIG. 19, showing the circuit board of FIG. 1.

FIG. 22b is a front perspective view of the vertical board electrical connector of FIG. 19.

FIG. 23 is a front perspective view of a housing of the vertical board connector of FIG. 22a.

FIG. 24 is a rear perspective view of the housing of FIG. 23.

FIG. 25 is a perspective view of a panel seal of the vertical board electrical connector of FIG. 19.

FIG. 26 is a perspective view of an electronic system, according to a second exemplary embodiment of the present disclosure.

FIG. 27 is a perspective view of an electronic system, according to a third exemplary embodiment of the present disclosure.

FIG. 28 is a perspective view of an electronic system, according to a fourth exemplary embodiment of the present disclosure.

### DETAILED DESCRIPTION

The inventors have recognized and appreciated connector designs for providing both high speed signals and power signals that may operate reliably in the harsh environment presented by an automobile. The inventors have recognized and appreciated various techniques that may be applied to components of the connector system to provide reliable power simultaneously in the vicinity of high speed signal transmission paths. For example, such techniques may be used in connectors used to construct Ethernet connector system for the automotive environment.

According to aspects of the present disclosure, an electrical connector may include a housing comprising a front portion, a rear portion, one or more subassembly chambers each for receiving a terminal subassembly, and multiple terminal channels each for receiving an individual terminal. Each terminal subassembly may include terminals configured for transmitting high-speed signals. The individual terminals may be configured for transmitting power signals and/or low-speed signals. Such a configuration may enable the terminal subassemblies and the terminals to be economically assembled to the housing.

In some embodiments, the plurality of individual terminals may be arranged in an array. For example, ten terminals may be arranged in two rows and five columns to form a 2×5 array. Exemplarily, eight terminals may be arranged in two rows and four columns to form a 2×4 array. As another example, six terminals may be arranged in two rows and three columns to form a 2×3 array.

In some embodiments, the one or more terminal subassemblies may be arranged in an array. For example, two terminal subassemblies may be disposed side by side to form a 1×2 array. Each terminal subassembly may include one or more signal terminals held by an insulating member. Each first signal terminal may include a mating end and a tail end. The mating end configured to mate with a terminal subassembly of a mating electrical connector. In some embodiments, the tail end may be configured to be connectable to a conductive element, such as a cable. In some embodiments, the tail end may be configured to mount to a circuit board. In some embodiments, each terminal subassembly may be configured to carry a signal, either as a single-ended signal or as a differential signal. In the exemplary embodiments illustrated below, each terminal subassembly has a pair of signal terminals suitable for carrying a differential signal.

According to aspects of the present disclosure, the electrical connector may be a plug connector configured to be inserted into a mating receptacle connector. The plug connector may include receptacle terminals configured for receiving plug terminals of the mating receptacle connector.

In some embodiments, each receptacle terminal may include a mating end and a tail end, with the mating end configured to mate with a terminal of a mating electrical connector such as one mounted onto a circuit board, and the tail end configured to be connectable to a conductive clement such as a cable. Optionally, a part of the receptacle terminals may be configured to transmit power signals and the others are configured to transmit low-speed signals. Optionally, all of the receptacle terminals may be configured to transmit power signals, or all be configured to transmit low-speed signals.

In some embodiments, a terminal position assurance device may be provided on the housing to restrain movements of the receptacle terminals in a mating direction. For example, the plurality of receptacle terminals may be arranged in two rows. Each row may be parallel to a first lateral direction perpendicular to the mating direction. The terminal position assurance device may be U-shaped, and may have two arms. Each arm may be configured to lock one row of terminals. For example, the receptacle terminal may be provided with a groove or a bulge, and the arm may be inserted into the groove substantially in the first lateral direction or block the bulge at its backside (e.g., a side facing the rear portion of the inner housing). Such a configuration may reduce the risk that the plurality of terminals accidentally exit the housing from the rear portion. Exemplarily, the arm may comprise a projection on an inner surface thereof facing the interior of the inner housing, and the plurality of terminals may be blocked from exiting the housing by the projection. Exemplarily, the projection may be disposed inside the housing. The housing may be provided with a locking slot, and the arm may extend into the locking slot. Exemplarily, the projection may protrude from the arm where it is located in the first lateral direction. For example, the arm may span a part of the receptacle terminals in a corresponding row in the first lateral direction, and the projection may span all of the receptacle terminals in the corresponding row in the first lateral direction.

In some embodiments, the terminal position assurance device may be fixed to the housing by the arms. Exemplarily, one side of the terminal position assurance device may be engaged with a corresponding side of the locking slot by a guiding feature and a guiding groove, and the other side of the terminal position assurance device may be engaged with a corresponding side of the locking slot by a barb and a notch.

In some embodiments, the housing may be provided with slits, each receptacle terminal may be provided with a beam which may be engaged with a slit, to reduce the risk that the receptacle terminals accidentally exiting the inner housing.

According to aspects of the present disclosure, the electrical connector may be a receptacle connector configured to receive a mating electrical connector (e.g., the plug connector described herein) for interconnecting two electronic devices in the electronic system. The receptacle connector may include plug terminals configured for inserting into the receptacle terminals of the plug connector.

In some embodiments, the electronic system may comprise a board connector and a cable connector. The board connector may be configured for mounting onto a circuit board, and the cable connector may have cables that can be connected to an electronic device that is at a certain distance from the circuit board. By connecting the board connector with the cable connector, the electronic device can be interconnected to the circuit board. In some embodiments, the plug connector may be configured as a cable connector, and the receptacle connector may be configured as a board connector.

In some embodiments, the front portion of the housing of the receptacle connector may be provided with a single front opening. The front portion of the plug connector may be inserted into the front opening of the receptacle connector. The rear portion of the receptacle connector may include the subassembly chamber and the terminal channels, both of which may be aligned with the front opening. Plug terminals may be accommodated in the plurality of terminal channels in a one-to-one correspondence. A terminal subassembly may be accommodated in the subassembly chamber.

In some embodiments, an electronic system may comprise a panel and a board connector. The panel may comprise an opening. The board connector may be fixed to the panel by a fastener. The board connector may comprise a housing, and a plurality of plug terminals and a terminal subassembly disposed in the housing. A front portion of the housing may extend through the opening to an outer side of the panel. Exemplarily, a flange may protrude in a lateral direction from an outer sidewall of the housing. The flange may abut against an inner surface of the panel so as to limit the position of the board connector with respect to the panel. The board connector may be then connected to the panel by the fastener. The fastener may be connected together with the housing after passing through the panel inwardly. Such a configuration may increase manufacturing tolerance because a through hole in the panel may be machined corresponding to the fastener, regardless of the relevant positioning between the opening and holes in the flange of the connector.

In some embodiments, a panel seal may be sandwiched between the flange and the inner surface of the panel. Such a configuration may enable a smaller portion of the electrical connector to be left outside the panel for a clean appearance. Exemplarily, the panel seal may be configured to enclose a hole for mounting the fastener, whereupon the panel seal can seal around both the opening and the hole. The panel may be part of an outer cover encapsulating the circuit board to which the board connector is connected. The panel seal can reduce the risk that foreign objects enters into the outer cover. In some embodiments, the panel seal may comprise a tab, the housing may comprise a recess, and the tab may be disposed in the recess so as to reduce the risk that the panel seal is accidentally detached from the housing.

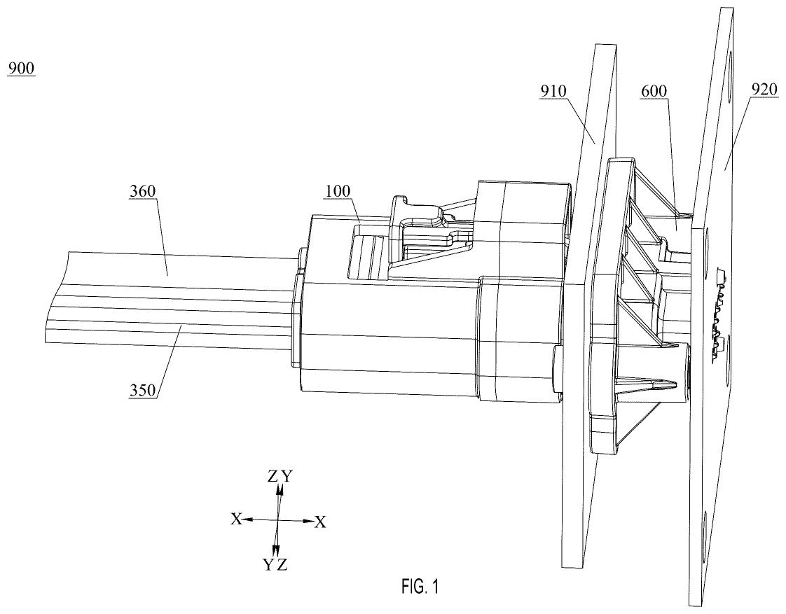

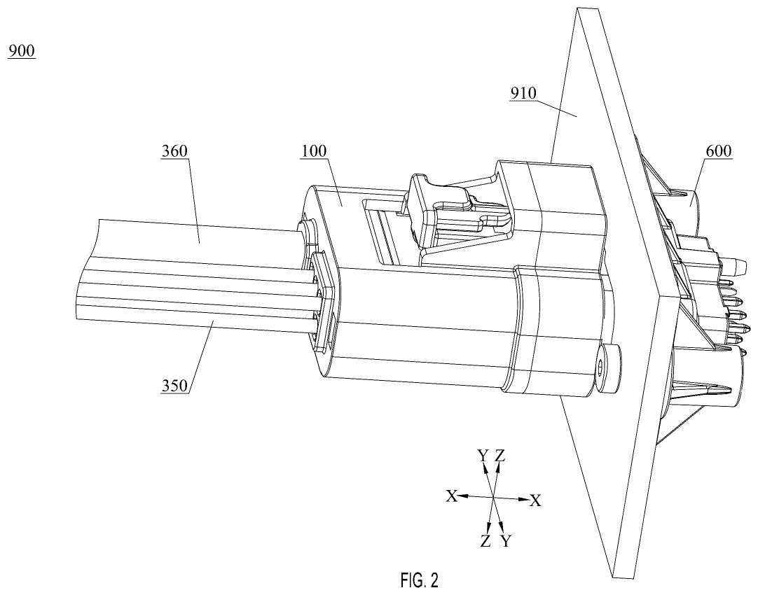

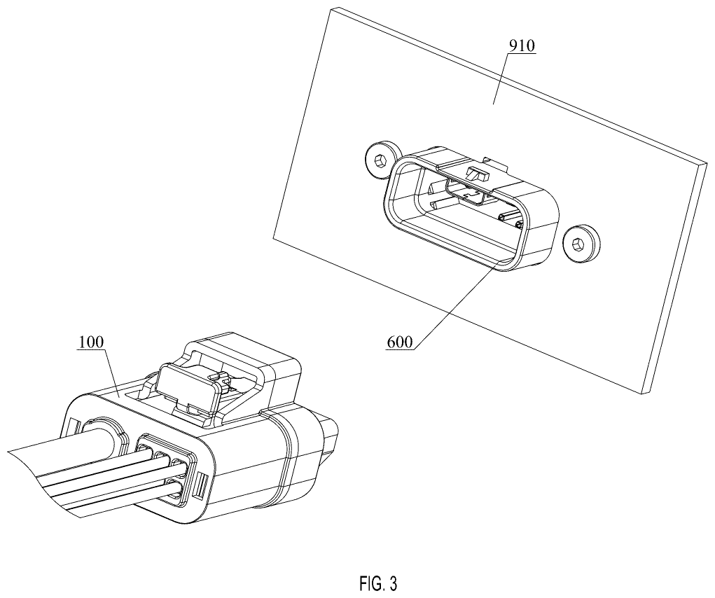

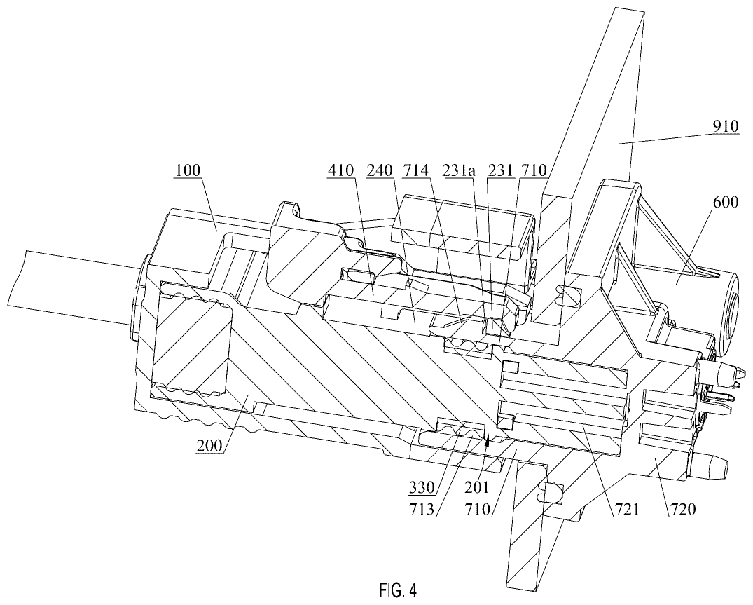

FIGS. 1-2 illustrate a portion of an electronic system 900 used, for example, in a vehicle, and the portion is for interconnection of multiple electronic devices in the electronic system 900. As shown in FIGS. 1-2, the electronic system 900 may comprise a cable connector 100 and a board connector 600. The board connector 600 may be mounted onto a circuit board 920. FIGS. 3-4 are schematic views of the electronic system 900 with the circuit board 920 hidden. The cable connector 100 may be selectively connected to the board connector 600. The cable connector 100 may be electrically connected via cables to an electronic device, such as another circuit board. The cable connector 100 and the board connector 600 may provide an interconnection between the electronic device and the circuit board 920. The electronic device may have a distance to the circuit board 920. For example, the board connector 600 as a receptacle connector may be mounted onto a target object, whereupon the board connector 600 may be mounted directly onto the circuit board 920. The cable connector 100 as a plug electrical connector may be adaptively connected to the receptacle connector. In alternative embodiments not shown, the cable connector 100 may be mounted directly onto the circuit board, while the board connector 600 is configured to be a cable connector to interconnect a remote electronic device to the circuit board. Optionally, both the cable connector 100 and the board connector 600 may be connected to respective electronic devices, such as circuit boards via cables. In some embodiments, one of the cable connector 100 and the board connector 600 may be fixed to the target object. In harsh environments such as those presented by vehicles, the electronic system 900 can provide high data rate transmission while withstanding vibration.

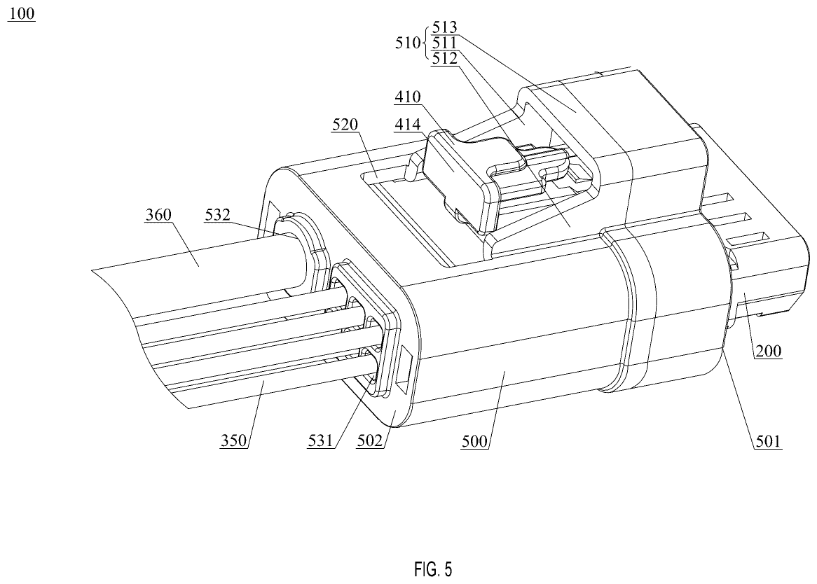

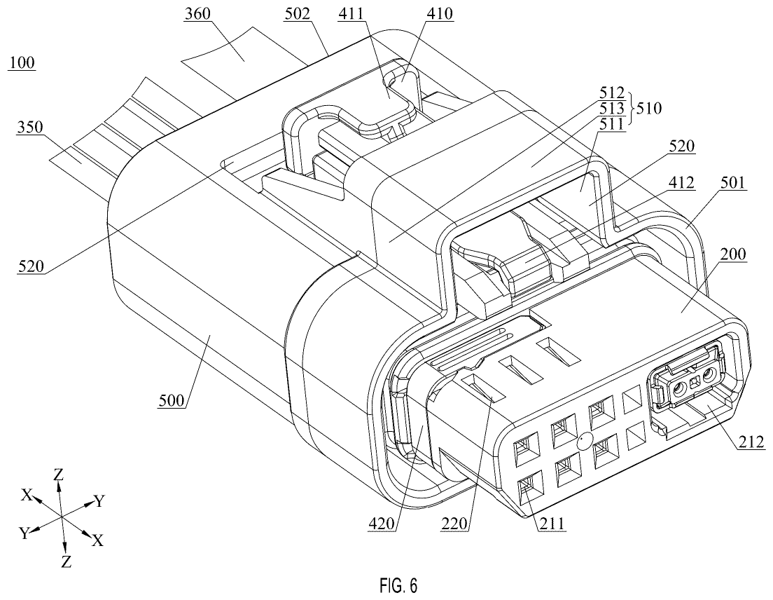

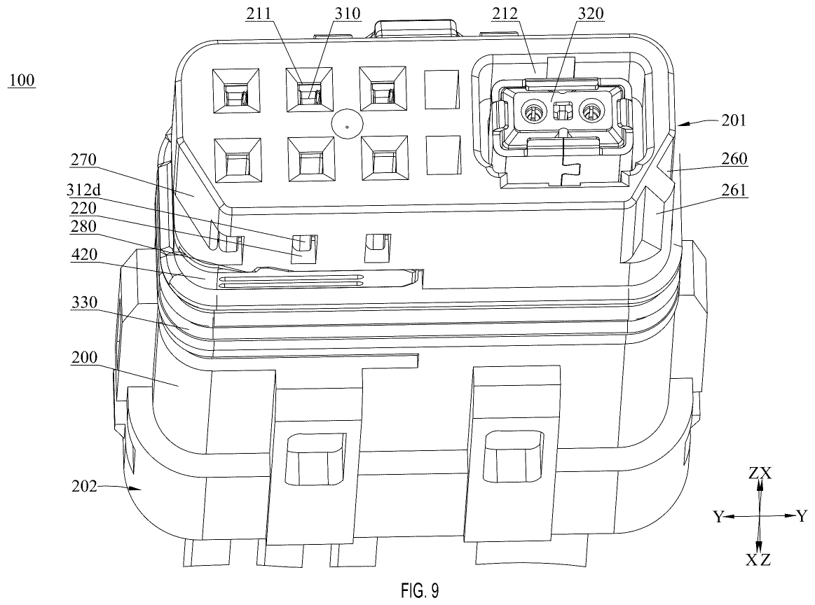

FIGS. 5-11 each illustrate, from a different angle, the structure of the cable connector 100 according to an embodiment of the present disclosure, wherein compared with FIGS. 5-6, in

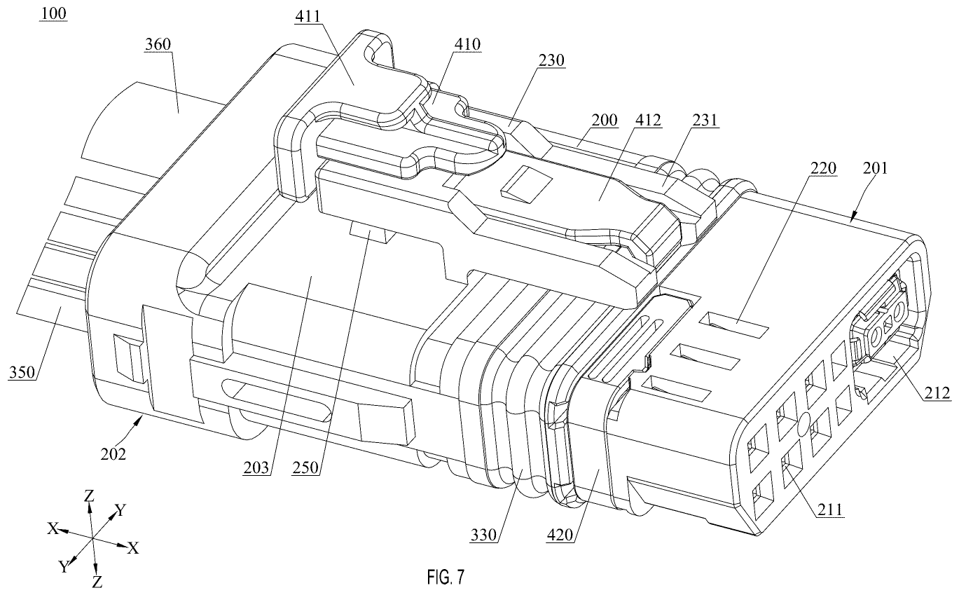

FIGS. 7-11, an outer housing 500 is hidden. For clear and concise description, a mating direction X-X, a first lateral direction Y-Y and a second lateral direction Z-Z may be illustrated. Any two of the second lateral direction Z-Z, the mating direction X-X and the first lateral direction Y-Y may be perpendicular to each other.

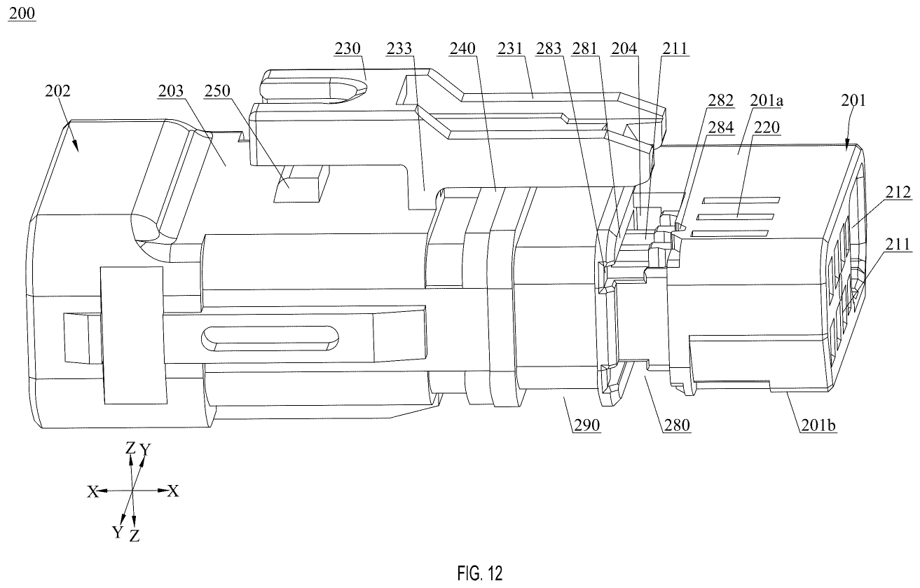

As shown in FIGS. 5-11, the cable connector 100 may comprise an inner housing 200. The inner housing 200 and a housing 700 as described hereinafter may be insulating. The inner housing 200 and/or the housing 700 may be molded with insulating materials, such as plastics. Plastics may include but not limited to liquid crystal polymers (LCP), polyphenylene sulfite (PPS), high-temperature nylon or poly-p-phenylene oxide (PPO), or polypropylene (PP), or other materials may be used. In some cases, plastics may be thermosetting plastics. In some cases, insulating plastics may include such as a fiberglass-reinforced insulating material. The inner housing 200 and the housing 700 may each be a one-piece member. FIGS. 12-14 illustrate the structure of the inner housing 200, and as shown, the inner housing 200 may have a front portion 201 and a rear portion 202. The front portion 201 may be configured to mate with the board connector 600 in a mating direction X-X. The rear portion 202 may be backwardly oriented relative to the board connector 600. A plurality of terminal channels 211 and a subassembly chamber 212 may be provided inside the inner housing 200. The terminal channels 211 and the subassembly chamber 212 may extend from the front portion 201 to the rear portion 202, respectively. In the illustrated embodiment, the front portion 201 and the rear portion 202 both extend in the mating direction X-X and are located at two ends of the inner housing 200. In this case, the terminal channels 211 and the subassembly chamber 212 may extend in the mating direction X-X. In other embodiments not shown, the front portion 201 and the rear portion 202 may be perpendicular to each other, and the rear portion 202 may extend in a lateral direction perpendicular to the mating direction X-X (e.g., a first lateral direction Y-Y or a second lateral direction Z-Z). In this case, the terminal channels 211 and the subassembly chamber 212 may have bends. Optionally, the front portion 201 and the rear portion 202 may also have other angles therebetween.

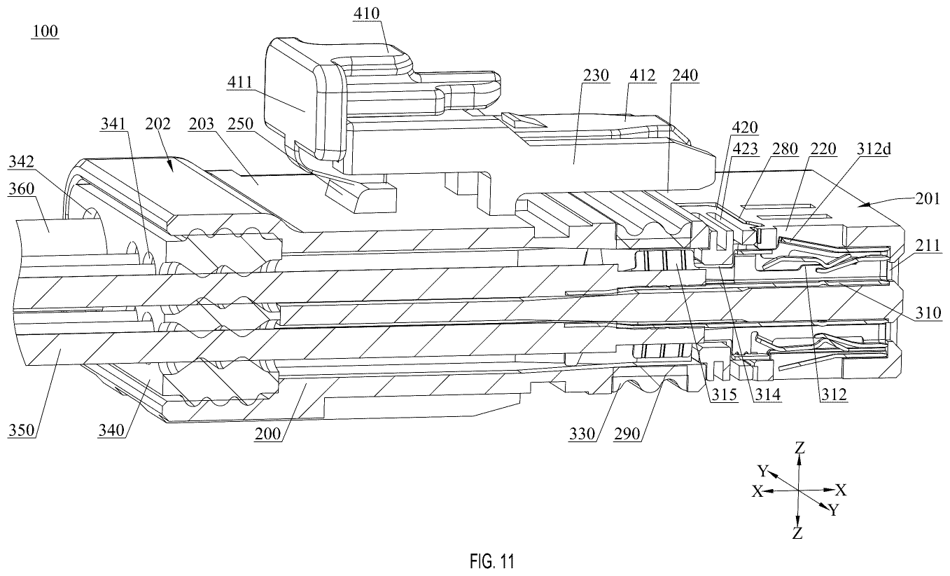

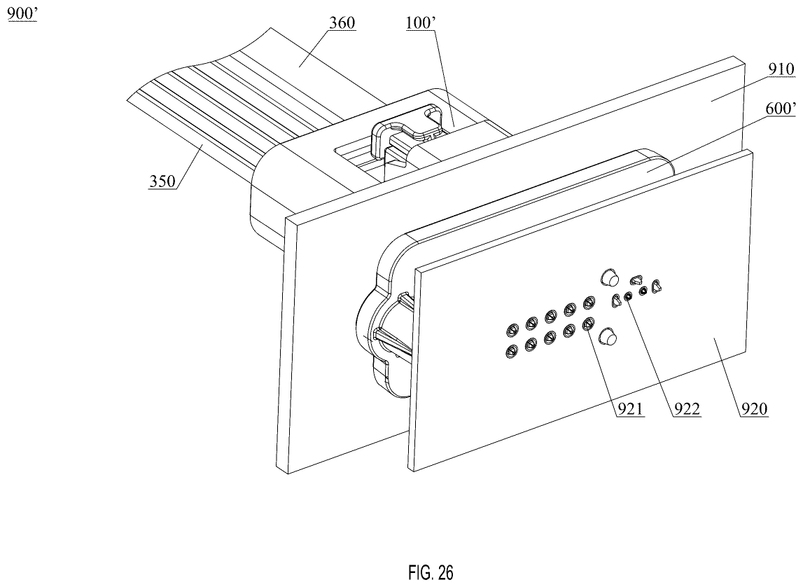

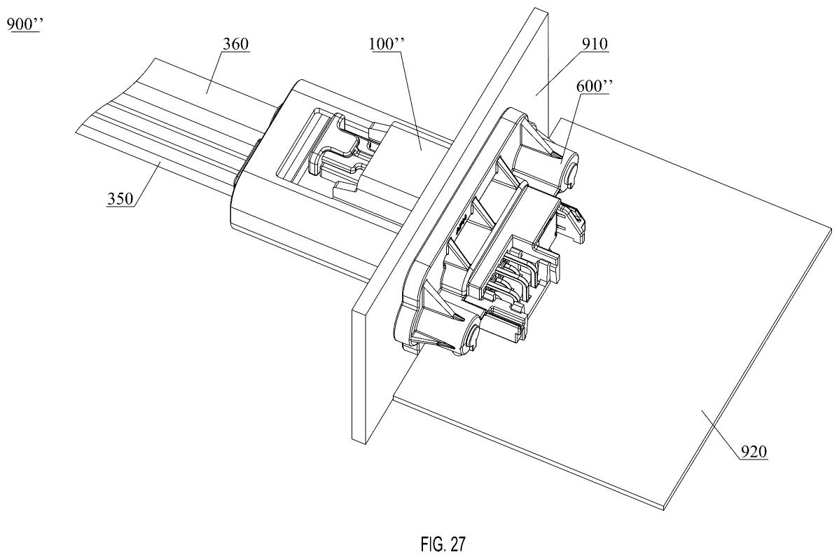

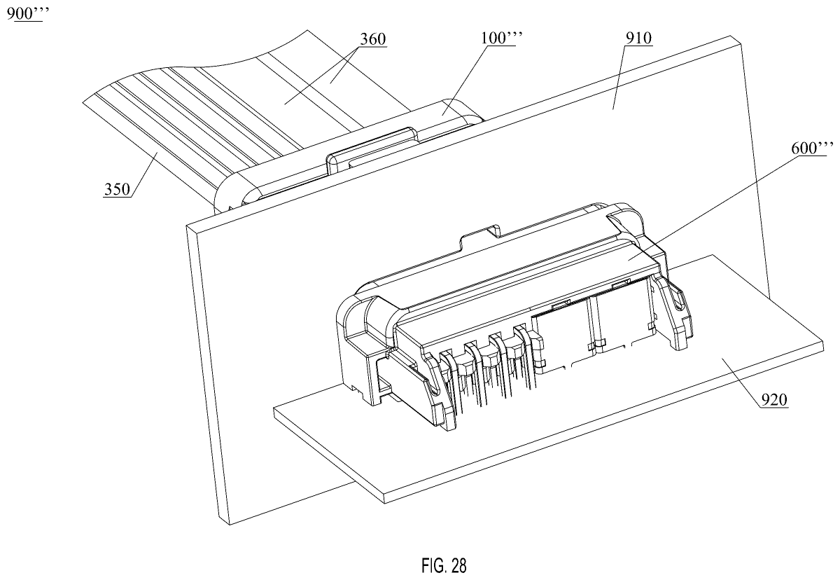

The cable connector 100 may also comprise a plurality of receptacle terminals 310, as shown in FIG. 11. The number of receptacle terminals 310 may be, for example, two, three, or more. In some embodiments, the number of the receptacle terminals 310 may be an even number, such as two, four, six, or more. In the illustrated embodiment, the number of the receptacle terminals 310 may be six. The six receptacle terminals 310 may be arranged in two rows parallel to the first lateral direction Y-Y and three columns parallel to the second lateral direction Z-Z, to form a 2×3 array. For example, each row may include three receptacle terminals 310 arranged in the first lateral direction Y-Y. The two rows of receptacle terminals 310 may be spaced apart in the second lateral direction Z-Z. In an electronic system 900′ illustrated in FIG. 26, as shown by the number of first cables 350 of a cable connector 100′ and that of holes 921 on the circuit board 920, the number of receptacle terminals thereon may be ten. The ten receptacle terminals may form a 2×5 array. As another example, in an electronic system 900″ illustrated in FIG. 27, six receptacle terminals of a cable connector 100″ may form a 2×3 array. As a further example, in an electronic system 900′″ illustrated in FIG. 28, eight receptacle terminals of a cable connector 100′″ may form a 2×4 array. Regardless of the number of receptacle terminals 310, the receptacle terminals 310 are provided in a one-to-one correspondence with the terminal channels 211 such that each receptacle terminal 310 can be disposed in a corresponding terminal channel 211. In this way, the plurality of receptacle terminals 310 can be assembled efficiently and economically, and adjacent receptacle terminals 310 can be disposed spaced apart to ensure that the plurality of receptacle terminals 310 can be insulated from each other.

Each receptacle terminal 310 may be configured to transmit power signals and/or low-speed signals. In the cable connector 100, all of the receptacle terminals 310 may be configured to transmit low-speed signals; or all may be configured to transmit power signals; or a part of the receptacle terminals 310 may be configured to transmit low-speed signals and the others are configured to transmit power signals. In the case that the receptacle terminals 310 are used for transmitting power signals, they may supply reliable power. The low-speed signals may include auxiliary information and/or control signals. The low-speed signals may include signals responsible for supporting and managing data transmission. The control signals may include one or more of control commands, status information, error detection and correction, and the like. The auxiliary information may include one or more of checksums, flow control, clock synchronization, and the like. The auxiliary information helps ensure data integrity, reliability and synchronization. Optionally, various configurations and functions of the device may further be managed by the receptacle terminals 310. For example, the electronic system 900 may send management commands to the electronic device via the receptacle terminals 310 to modify configuration parameters, inquire about device status, identify device information, and the like. As a result, the receptacle terminals 310 and the paths for signal transmission connected thereto may adaptively adopt materials and/or structures that support only low-speed signals, which may be cost-saving. In some embodiments, the receptacle terminals 310 may transmit low-frequency signals (e.g., with a frequency of less than 66 MHz), signals with lower data rates (e.g., less than 100 Mb/s), logic control signals, and the like.

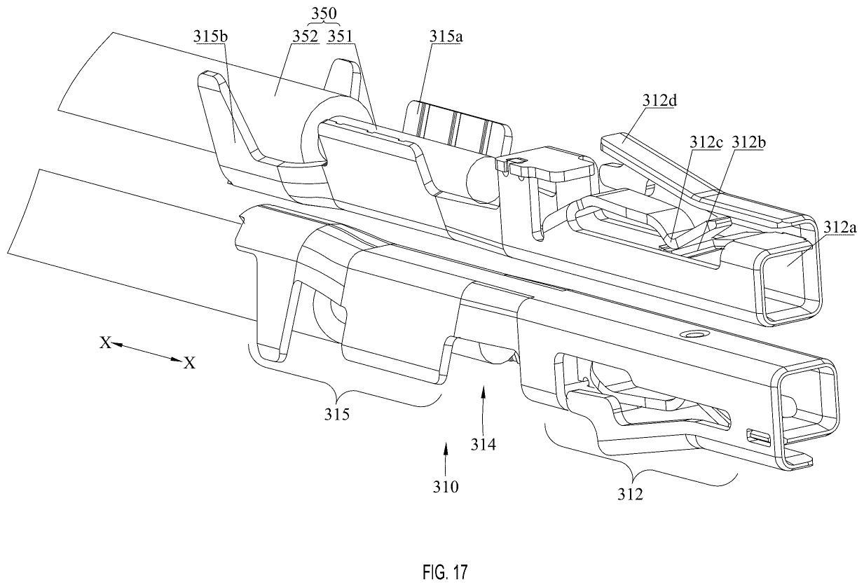

Exemplarily, the receptacle terminals 310 may be disposed in respective corresponding terminal channels 211 from one side of the rear portion 202. As shown in FIG. 17, each receptacle terminal 310 may include a mating end 312 and a tail end 315. The mating end 312 and the tail end 315 may be disposed at two ends of the receptacle terminal 310. When each receptacle terminal 310 is disposed in the respective terminal channel 211 in place, the mating end 312 may abut against the front portion 201 of the inner housing 200 to improve assembly efficiency. The mating end 312 is configured to electrically contact a corresponding plug terminal 810 (described in more detail below) of the board connector 600. In this way, the electrical connection between the cable connector 100 and the board connector 600 can be achieved to transmit low-speed signals or power signals. The tail end 315 is configured to connect the first cables 350. To reduce costs and ensure reliability of the connection, a portion of the first cable 350 may extend into the terminal channel 211, as shown in FIG. 11. In some embodiments, the receptacle terminal 310 substantially has a straight line appearance. In the illustrated embodiment where the terminal channel 211 extends in the mating direction X-X, the portion of the first cable 350 in the terminal channel 211 is also straight. However, in the embodiment where the front portion and the rear portion are at an angle such that the terminal channel is curved, the portion of the first cable in the terminal channel may be curved to fit with the shape of the terminal channel.

Back to FIG. 17 for reference, the first cable 350 may include a conductive core 351 and an insulating sheath 352 cladded over the conductive core 351. A portion of the insulating sheath 352 is stripped from the end of the first cable 350 to be terminated to the receptacle terminal 310 to expose a section of the conductive core 351. The exposed conductive core 351 and a portion of the insulating sheath 352 adjacent to the exposed conductive core 351 may be placed on the tail end 315. The tail end 315 may be provided with a first crimping tab 315a. The first crimping tab 315a may be shaped in accordance with IPC620 Standards established by International

Federation of Electronic Component Industries. The first crimping tab 315a may be crimped onto the conductive core 351 of the first cable 350. In some embodiments, the receptacle terminal 310 may be made of metallic materials that may have good plasticity. The first crimping tab 315a can be easily crimped onto the conductive core 351 and also be in electrical contact with the conductive core 351. The first crimping tab 315a crimped onto the conductive core 351 is higher than the conductive core 351. The first crimping tab 315a can be spaced apart from the mating end 312 to form a terminal locking slot 314 (which will be described in more detail below). To firmly secure the conductive core 351, the first crimping tabs 315a may be provided in pairs. A pair of first crimping tabs 315a may not overlap with each other after being crimped onto the conductive core 351. In addition, by adjusting the dimension of the first crimping tab 315a, it is also possible to form a desired contact area between the first crimping tab 315a and the conductive core 351, thereby realizing impedance matching.

Optionally, the tail end 315 may further be provided with a second crimping tab 315b. The second crimping tab 315b may be crimped onto the folded insulating sheath 352. Optionally, if the stripped insulating sheath 352 is removed, it can be crimped directly onto a next adjacent section of the insulating sheath 352. There may be one or more second crimping tabs 315b. When a plurality of second crimping tabs 315b exist, optionally, the plurality of second crimping tabs 315b may also be staggered from each other in the mating direction X-X so that they may not overlap with each other when being crimped onto the insulating sheath 352 to avoid oversize there. Exemplarily, the plurality of second crimping tabs 315b may be complementary in shape such that they can be crimped onto the insulating sheath 252 occupying a large portion, thereby ensuring a strong connection. In the mating direction X-X, the second crimping tabs 315b may be spaced apart from the first crimping tabs 315a by a distance, and this distance ensures that, in the event of a deviation in handling the end of the first cable 350 such that the conductive core 351 protrudes too much or too little with respect to the insulating sheath 352, it is still possible to ensure that the first crimping tabs 315a are crimped onto the conductive core 351 only, and the second crimping tabs 315b are crimped onto the insulating sheath 252 only to avoid affecting the electrical properties of the cable connector 100.

Exemplarily, the mating end 312 may include a conductive sleeve 312a for receiving a corresponding plug terminal 810 of the board connector 600. The conductive sleeve 312a may include a first beam 312b and a second beam 312c. The first beam 312b and the second beam 312c both are in the form of a cantilever with one end being free, and the free ends of the two overlap with each other and are bent toward the inner of the conductive sleeve 312a to increase the resilience of the overlapped portions. When the corresponding plug terminal 810 of the board connector 600 is inserted into the conductive sleeve 312a, the bent portions of the first beam 312b and the second beam 312c abut against the plug terminal 810. As a result, reliable electrical contact between the receptacle terminal 310 and the plug terminal 810 can be ensured, and the plug terminal 810 can be firmly retained inside the receptacle terminal 310. Exemplarily, each receptacle terminal 310 may be formed by bending a piece of metal. The first beam 312b and the second beam 312c as well as the aforementioned first crimping tab 315a and the second crimping tab 315b can be formed by stamping or cutting edges of a metal sheet and then bending them. The first beam 312b and the second beam 312c may be disposed on one side of the metal sheet.

A third beam 312d may be provided on the other side of the metal sheet. Exemplarily, the third beam 312d may be machined by an outwardly bent cantilever of the metal sheet, with a free end of the cantilever being the third beam 312d. The third beam 312d may be engaged with a position assurance feature, such as a slit 220, of the inner housing 200, as shown in FIG. 11, so as to prevent the receptacle terminal 310 from exiting the inner housing 200. In the second lateral direction Z-Z, each conductive sleeve 312a has a side facing the exterior of the inner housing 200, such as an upper side of the receptacle terminal 310 at the upper part in FIG. 17 and a lower side of the receptacle terminal 310 at the lower part in FIG. 17. The third beam 312d may be provided on this side. When each receptacle terminal 310 is inserted into a corresponding terminal channel 211 from one side of the rear portion 202, the resilient cantilever may enable the third beam 312d to smoothly enter into the terminal channel 211 and bounce back to engagement with the position assurance feature when the receptacle terminal 310 is inserted in place. In a direction opposite an inserting direction (e.g., a direction toward the rear portion 202), the third beam 312d abuts against a sidewall of the position assurance feature to prevent the receptacle terminal 310 from being detached from the inner housing 200 from one side of the rear portion 202. In other embodiments not shown, the third beam 312d may also have any other suitable structure, including, for example a strip cut from the receptacle terminal 310 with a middle of the strip protruding toward the inner housing 200, but with both ends of the strip connected to the receptacle terminal 310. With this configuration, it can also be ensured that the third beam is resilient and can be engaged with the position assurance feature.

Exemplarily, as shown in FIGS. 6-8 and FIGS. 11-13, there may be a plurality of slits 220. The plurality of slits 220 may be disposed in a one-to-one correspondence with the plurality of receptacle terminals 310. By arranging the plurality of receptacle terminals 310 in two rows, each row of receptacle terminals 310 has a side adjacent to the inner housing 200, and thus, the slits 220 may be disposed in the sidewalls of the inner housing 200 that are opposite each other in the second lateral direction Z-Z. One row of slits 220 may be disposed in each sidewall. Two rows of slits 220 may be engaged with adjacent rows of receptacle terminals 310, respectively. In the illustrated embodiment, the slits 220 penetrate from an inner surface to an outer surface of the inner housing 200. In other embodiments not shown, the slits 220 may be blind holes recessed from the inner surface of the inner housing 200. In some embodiments, the inner housing 200 is a molded member. Compared with blind holes, it is more convenient to process the slits 220 in form of holes. Moreover, it is easier to visually detect whether the third beams 312d have been engaged with the slits 220, for determining whether the cable connector 100 is qualified. And the slits 220 may also be configured to dissipate heat to reduce the temperature of the receptacle terminals 310. Furthermore, each row of receptacle terminals 310 may share the same slit. In this case, the slit is substantially in the form of a long slot extending in a direction parallel to the row. By providing a separate slit 220 for each receptacle terminal 310, the inner housing 200 can be less affected in terms of mechanical strength. Moreover, the slit 220 may be sized to fit a corresponding third beam 312d in the first lateral direction Y-Y. The slit 220 can also position a corresponding receptacle terminal 310 in the first lateral direction Y-Y. Exemplarily, as shown in FIG. 11, the slits 220 may correspond to the mating ends 312 in position. As previously described, it is easier to machine the mating ends 312 with the third beams 312d mating with the slits 220.

In the above embodiment, the position assurance feature, such as the slit 220, is utilized to block the third beam 312d in the direction toward the rear portion 202. Optionally, other position assurance features may be provided to limit the receptacle terminal 310 in the direction toward the front portion 201. Optionally, the plurality of receptacle terminals 310 may be limited by the same position assurance feature in the mating direction X-X (both the direction toward the rear portion 202 and the direction toward the front portion 201). Exemplarily, the mating end 312 may abut against the front portion 201 of the inner housing 200. The position assurance feature may be configured to limit the plurality of receptacle terminals 310 in the direction toward the rear portion 202. In this way, after the receptacle terminals 310 are mounted from one side of the rear portion 202 into the terminal channels 211 respectively, the front portion 201 and the position assurance feature may clamp the portions of the receptacle terminals 310 therebetween for positioning the receptacle terminals 310 in the mating direction X-X.

Alternatively or additionally, as shown in FIGS. 6-9 and 16a-16b, the position assurance feature may also include a terminal position assurance (TPA) device 420. The terminal position assurance device 420 may be mounted onto the inner housing 200 in the first lateral direction Y-Y. After the plurality of receptacle terminals 310 are disposed in the respective terminal channels 211 in place, the terminal position assurance device 420 may be mounted to the inner housing 200 in the first lateral direction Y-Y. Each receptacle terminal 310 may be provided with a terminal position assurance feature that mates with the terminal position assurance device 420, such as the terminal locking slot 314 in FIG. 17. The mating end 312 and tail end 315 of each receptacle terminal 310 are spaced apart to form the terminal locking slot 314. In other embodiments not shown, the terminal position assurance feature may have any other structure, including for example any suitable bulge or recess. Exemplarily, the terminal position assurance device 420 may abut against the mating ends 312 to limit the plurality of receptacle terminals 310 in the direction toward the rear portion 202. Optionally, the terminal position assurance device 420 may also abut against the tail ends 315 to limit the plurality of receptacle terminals 310 in the direction toward the front portion 201.

Exemplarily, as shown in FIGS. 6-9 and 16a-16b, in an embodiment where the plurality of receptacle terminals 310 are arranged in two rows parallel to the second lateral direction Z-Z, the terminal position assurance device 420 may include a first arm 431 and a second arm 432. The first arm 431 and the second arm 432 may be joined by a connecting portion 433 therebetween. In this way, the terminal position assurance device 420 may be substantially U-shaped. The first arm 431 and the second arm 432 may each lock one of the two rows of receptacle terminals 310. Thus, a single terminal position assurance device 420 can be configured to simultaneously limit the two rows of receptacle terminals 310. In this way, the number of parts can be reduced. Exemplarily, the first arm 431 and the second arm 432 may be disconnected parts, which may be separately mounted onto the inner housing 200.

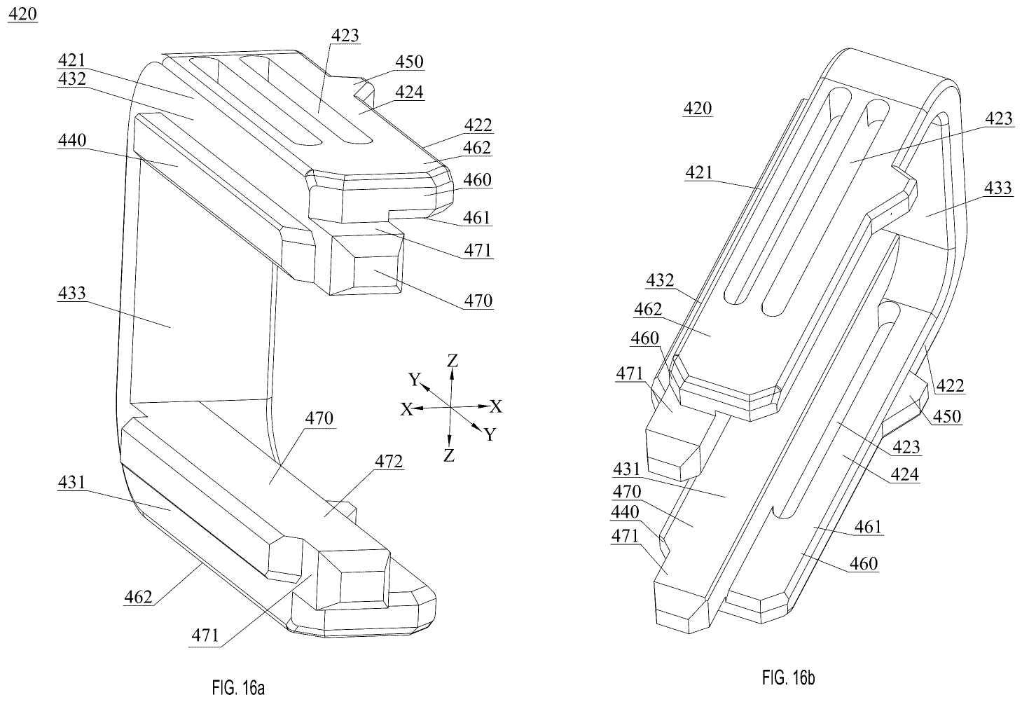

Exemplarily, as shown in FIG. 12, the inner housing 200 may be provided with a locking slot 280 extending in the first lateral direction Y-Y. The front portion 201 of the inner housing 200 has a top surface 201a and a bottom surface 201b opposite each other in the second lateral direction Z-Z. Each of the top surface 201a and the bottom surface 201b is provided with the locking slot 280 inwardly recessed. The two locking slots 280 may be mounted with the first arm 431 and the second arm 432, respectively. For each locking slot 280, it may have a first locking slot sidewall 281 and a second locking slot sidewall 282 opposite each other in the mating direction X-X. A second guiding groove 283 may be disposed in the first locking slot sidewall 281. A notch 284 may be disposed in the second locking slot sidewall 282. An opening of the notch 284 may be oriented toward the first locking slot sidewall 281. As shown in FIG. 16a and FIG. 16b, the terminal position assurance device 420 may have a first side 421 and a second side 422 opposite each other in the mating direction X-X. The first side 421 may be provided with a guiding feature 440. The second side 422 may be provided with a barb 450. In the process of mounting the terminal position assurance device 420 to the inner housing 200 in the first lateral direction Y-Y, the guiding feature 440 may be inserted into the second guiding groove 283. In this way, the second guiding groove 283 can provide guidance for the terminal position assurance device 420. When the terminal position assurance device 420 is mounted in place, the barb 450 is trapped in the notch 284. In this way, the notch 284 can function to inhibit the terminal position assurance device 420 from being detached from the inner housing 200.

Exemplarily, as shown in FIGS. 16a and 16b, the terminal position assurance device 420 may be provided with a slit 423 extending in the first lateral direction Y-Y. The slit 423 may penetrate from an inner surface to an outer surface of the terminal position assurance device 420. The inner surface and the outer surface are disposed opposite each other in the second lateral direction Z-Z, with the inner surface and the outer surface facing the interior and the exterior of the inner housing 200, respectively. The slit 423 is closer to the second side 422 such that the distance from the slit 423 to the first side 421 is greater than the distance to the second side 422. As a result, a resilient beam 424 is formed between the slit 423 and the second side 422. The barb 450 is disposed at a position corresponding to the middle of the slit 423. Thus, in the process of mounting the terminal position assurance device 420 to the locking slot 280, the barb 450 can easily slide into the notch 284 in the sidewall of the locking slot 280 with the help of the resilience of the resilient beam 424. Exemplarily, referring in conjunction to FIGS. 6-9, 16a-16b, and 17, the locking slot 280 may correspond to the terminal locking slots 314 of the receptacle terminals 310 in position.

Exemplarily, the terminal position assurance device 420 may include a body 460. In the case where the terminal position assurance device 420 includes the first arm 431 and the second arm 432 connected to each other in a U-shape, the body 460 is in a U-shape. The body 460 may have an inner surface 461 facing the interior of the inner housing 200 and an outer surface 462 facing the exterior of the inner housing 200. Exemplarily, the slit 423 may be disposed in the body 460 and penetrate from the inner surface 461 to the outer surface 462. The barb 450 is disposed on the body 460. The inner surface 461 may be provided with a projection 470 extending in the first lateral direction Y-Y. In the mating direction X-X, the projection 470 may be closer to the first side 421 of the terminal position assurance device 420 to give way to the slit 423. In the case where the terminal position assurance device 420 is disposed in the locking slot 280, the projection 470 can extend into the terminal locking slot 314 of each receptacle terminal 310. The projection 470 may block the plurality of receptacle terminals 310 in the direction toward the rear portion 202. There may be two projections 470, in correspondence with two rows of receptacle terminals 310, respectively. The two projections 470 are disposed on two legs of the U-shaped body 460 to form the first arm 431 and the second arm 432, respectively.

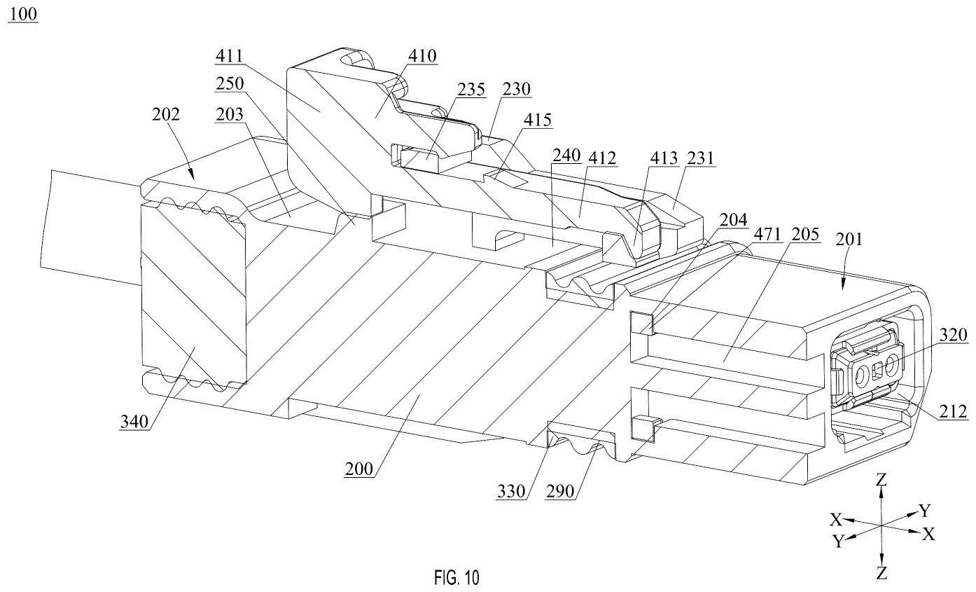

Exemplarily, referring in conjunction to FIGS. 11-12 and 16a-16b, the locking slot 280 for the terminal position assurance device 420 may span the plurality of receptacle terminals 310 in each row in the first lateral direction Y-Y. The body 460 may be fully accommodated within the locking slot 280 and span the plurality of receptacle terminals 310 in each row. As shown in FIG. 16a and FIG. 16b, the projection 470 may extend from the body 460 in the first lateral direction Y-Y, such that the projection 470 has a protruding end 471. The protruding end 471 may extend into an inner space 204 of the inner housing 200, as shown in FIG. 10. In addition, the inner housing 200 is provided with a dummy channel 205 in communication with the inner space 204. The dummy channel 205 may extend to an end surface of the rear portion 202 in the mating direction X-X. Optionally, the body 460 may span a part of the plurality of receptacle terminals 310 in each row in the first lateral direction Y-Y, instead of all of the receptacle terminals 310 in each row. In this way, the length of the locking slot 280 in the first lateral direction Y-Y is reduced to enhance the mechanical strength of the inner housing 200.

Exemplarily, as shown in FIGS. 16a and 16b, on the first side 421 of the terminal position assurance device 420, the projection 470 may be flush with the body 460, whereby the thickness of the terminal position assurance device 420 proximate the first side 421 may be increased. Thus, the first side 421 may have sufficient thickness to provide a sufficiently wide guiding feature 440, such that the guiding feature 440 has a greater mechanical strength. Exemplarily, as shown in FIGS. 16a and 16b, the guiding feature 440 may be flush with the inner surface 472 of the projection 470. The guiding feature 440 may be spaced apart from the outer surface 462 of the body 460. The guiding feature 440 expanding to the inner surface 472 of the projection 470 may have further increased width, and assure the position of the receptacle terminals 310 together with the projection 470. In addition, it is also possible to make the guiding feature 440 spaced apart from the outer surface 462 of the body 460 by a larger distance, and this distance matches with the thickness of the inner housing 200, thereby avoiding thinning the inner housing 200 and ensuring that the inner housing 200 has a sufficiently large mechanical strength.

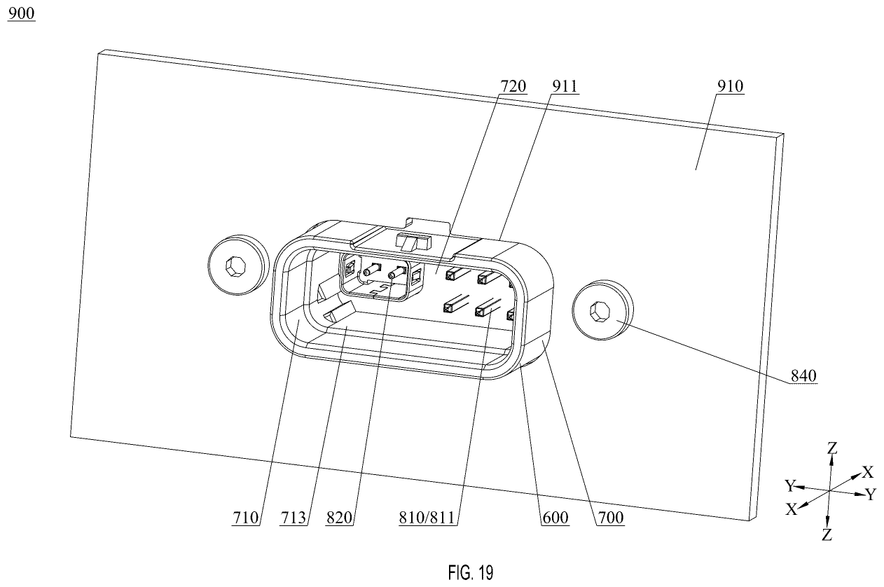

Exemplarily, as shown in FIGS. 4 and 7-11, the cable connector 100 may further comprise a mating end seal 330. The mating end seal 330 may be disposed at an outer surface of the front portion 201 of the inner housing 200. The mating end seal 330 may surround the front portion 201 in a circumferential direction perpendicular to the mating direction X-X. For example, as shown in FIGS. 12-14, an annular recess 290 may be disposed in the outer surface of the front portion 201. The mating end seal 330 may extend into the annular recess 290. When the cable connector 100 is connected to the board connector 600, the mating end seal 330 may be clamped between the front portion 201 and the board connector 600, as shown in FIG. 4. As shown in FIGS. 19-21, 22a, 22b, and 23-24, the board connector 600 may comprise a housing 700 and a plurality of plug terminals 810. The housing 700 may include a front portion 710 and a rear portion 720. The front portion 710 may have a front end 711 and a rear end 712. The front end 711 and the rear end 712 may be disposed opposite each other in the mating direction X-X. The front portion 710 may be provided with a single front opening 713. The front opening 713 may extend from the front end 711 to the rear end 712. The rear portion 720 may be connected to the rear end 712. The rear portion 720 may have a plurality of terminal channels 721. The plurality of plug terminals 810 may be disposed in the terminal channels 721 correspondingly. This allows for economical and fast assembly of the plurality of plug terminals 810 with the housing 700, and ensures that the plurality of plug terminals 810 are insulated from each other.

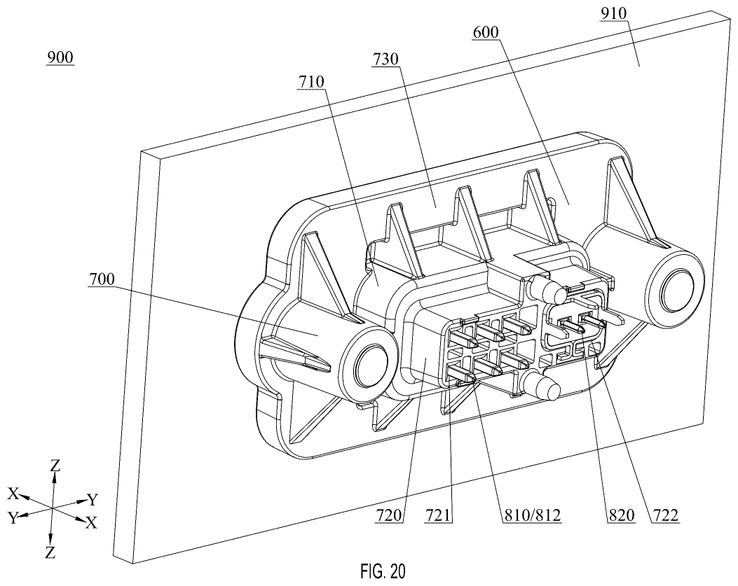

The terminal channels 721 may be aligned with the front opening 713. The plug terminals 810 may be in a one-to-one correspondence with the receptacle terminals 310 for transmitting power and/or low-speed signals. Each plug terminal 810 may include a mating end 811 (shown in FIG. 19) and a tail end 812 (shown in FIG. 20) at both ends thereof. The mating end 811 may extend into the front opening 713. When the cable connector 100 is connected to the board connector 600, the front portion 201 of the cable connector 100 may be inserted into the front opening 713, and the mating end 811 be inserted into a corresponding terminal channel 211 of the front portion 201 to electrically contact a corresponding receptacle terminal 310, thereby enabling the electrical connection between the cable connector 100 and the board connector 600. Exemplarily, the mating end seal 330 may be clamped between an outer sidewall of the front portion 201 and an inner sidewall of the front opening 713, as shown in FIG. 4. In this way, contaminants such as dirt are less likely to enter into the front portion 201 and the front opening 713 to affect the electrical connection between the front portion 201 and the front end 711, serving as waterproof and dustproof, and thereby ensuring the reliability of the cable connector 100 and the board connector 600. In addition, the mating end seal 330 is usually deformed by being squeezed between the outer sidewall of the front portion 201 and the inner sidewall of the front opening 713, and thus can act as a shock absorber.

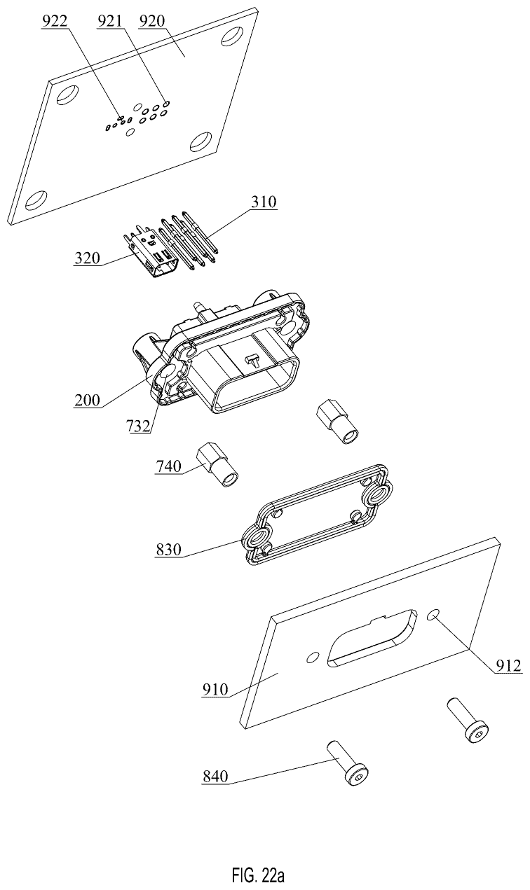

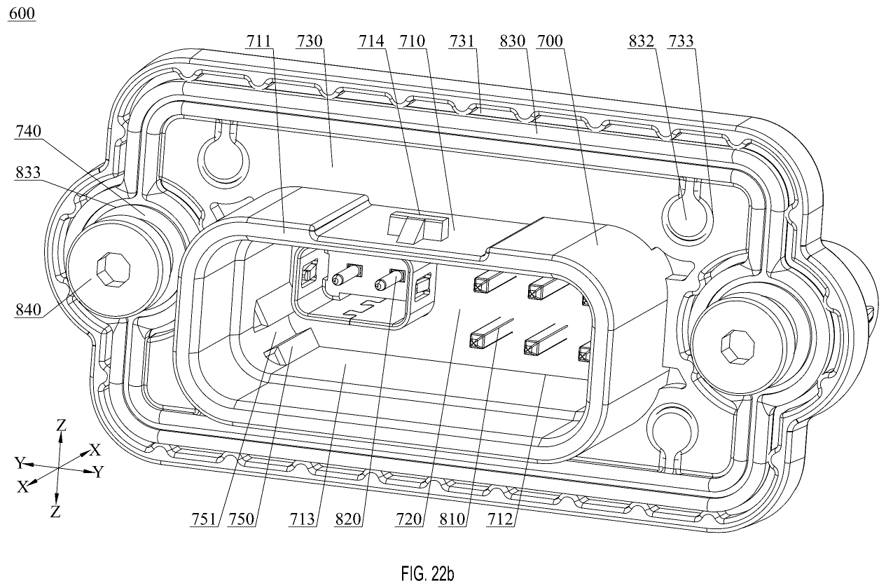

The tail ends 812 may extend beyond the rear portion 720, as shown in FIG. 20. The tail ends 812 may be mounted to the circuit board 920 by technologies such as Surface Mounted Technology (SMT) and/or Through-Hole Technology (THT), thereby achieving an electrical connection to the circuits of the circuit board 920. Depending on the mounting technology, the tail ends 812 may be configured as pins, SMT tails, or press-mounting tails and so on. Optionally, terminal through holes 921 are provided in the circuit board 920, as shown in FIG. 22a. The arrangement pattern of the terminal through holes 921 may correspond to that of the tail ends 812 of the board connector 600 to be connected. Optionally, a sidewall of each terminal through hole 921 may be plated with a metal conductive layer. The tail ends 812 may be inserted into corresponding terminal through holes to electrically contact the metal conductive layers. The metal conductive layers of these terminal through holes 921 can be electrically connected to different conductive traces within the circuit board 920 to form the desired circuitry. In this way, the board connector 600 and the circuit board 920 can be interconnected, for transmitting power and/or low-speed signals.

Exemplarily, the plug terminals 810 may be made of a conductive material, such as metal. Each plug terminal 810 may be an elongated one-piece member. Depending on the type of the board connector 600, the plug terminals 810 may be in different shapes. In the embodiments illustrated in FIGS. 1-4, 19-21, 22a, 22b, and 23-26, the board connector 600 may be a vertical connector. The plug terminal 810 may be substantially in the shape of a straight line in the mating direction X-X. In the embodiments illustrated in FIGS. 27 and 28, board connectors 600″ and 600″ may be right-angle connectors. The plug terminal 810 may be substantially L-shaped.

As shown in FIGS. 6 and 9-10, the cable connector 100 may further comprise a terminal subassembly 320. The terminal subassembly 320 may include an outer insulating sheath and one or more signal terminals disposed inside the insulating sheath. In the illustrated embodiment, the terminal subassembly 320 may include two signal terminals for forming a differential signal terminal pair.

The number of terminal subassemblies 320 may be configurable, including but not limited to one, two, or more. In the embodiments illustrated in FIGS. 1-21, 22a, 22b, and 23-24, 26, and 27, there may be one terminal subassembly 320. In the embodiment illustrated in FIG. 28, there may be two terminal subassemblies thereon, as shown by the numbers of second cables 360 and signal through holes 922 in the circuit board 920. The two terminal subassemblies may be arranged in the first lateral direction Y-Y. The terminal subassemblies may be disposed in the first mounting cavities correspondingly. In this way, the terminal subassemblies 320 can be quickly and economically assembled into the respective subassembly chambers. The terminal subassemblies 320 may be mounted from one side of the rear portion 202 into the respective corresponding subassembly chambers 212.

Each of the terminal subassemblies 320 may be used for transmitting high-speed signals. A differential signal terminal pair of each terminal subassembly 320 may be configured to carry high data-rate signals (e.g., signals carrying data rates over 25 Gb/sec with PAM4 encoding) or high-frequency signals (e.g., over 56 or 112 Gb/sec). The terminal subassemblies 320 for directly transmitting high-speed data are favorable for improving signal integrity and provide high data access speed and system response performance. The terminal subassemblies 320 may extend from the front portion 201 to the rear portion 202. Each terminal subassembly 320 may include a first signal mating end and a first signal tail end. The first signal mating end and the first signal tail end may be provided at two ends of the terminal subassembly 320. The first signal mating end may extend to the front portion 201. In this way, a terminal subassembly 820 of the board connector 600 (as described in more detail below) may be in electrical contact with the corresponding first signal mating end. Thus, the cable connector 100 can be electrically connected with the board connector 600 to transmit high-speed signals. The first signal tail end may be electrically connected to a second cable 360 for transmitting high-speed signals with an electronic device via the second cable 360.

To reduce costs and improve connection reliability, a portion of the second cable 360 may extend into the subassembly chamber 212. In some embodiments, the terminal subassembly 320 substantially has a straight line appearance. In the illustrated embodiment where the subassembly chamber 212 extends in the mating direction X-X, the portion of the second cable 360 in the subassembly chamber 212 is also straight. However, in the embodiment where the front portion and the rear portion are at an angle such that the subassembly chamber is curved, the portion of the second cable in the subassembly chamber may be curved to fit with the shape of the subassembly chamber.

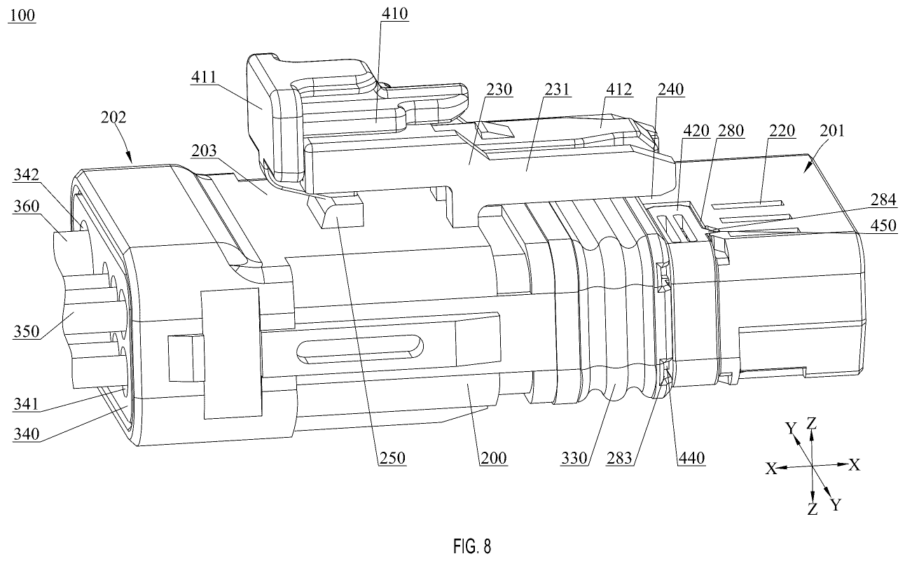

Exemplarily, as shown in FIGS. 8 and 11, the cable connector 100 may further comprise a tail end seal 340. The first cables 350 and the second cable 360 may pass through the tail end seal 340. For example, the tail end seal 340 may comprise first conduits 341 and a second conduit 342. The first cables 350 may pass through the first conduits 341 in a one-to-one correspondence. The second cable 360 may pass through the second conduit 342. The tail end seal 340 may be installed in the rear portion 202 of the inner housing 200. For example, the tail end seal 340 is compressed in the rear portion 202, for sealing the rear portion 202. In this way, contaminants such as dirt are unlikely to enter the inner housing 200 from the rear portion 202, which can ensure the reliability of the cable connector 100.

As shown in FIGS. 19-21, 22a, 22b, and 23-24, a subassembly chamber 722 may be disposed in the rear portion 720 of the housing 700 of the board connector 600. The subassembly chamber 722 may be aligned with the front opening 713 of the front portion 710 of the housing 700. The board connector 600 may also comprise a terminal subassembly 820. The terminal subassembly 820 may be disposed in the subassembly chamber 722. In this way, the terminal subassembly 820 may be fixed relative to the subassembly chamber 722. The terminal subassembly 820 may be mounted from a rear side of the rear portion 720 into the subassembly chamber 722.

The terminal subassembly 820 may be in correspondence with the terminal subassembly 320. The terminal subassembly 820 may include second signal mating ends and second signal tail ends. The second signal mating ends and the second signal tail ends may be disposed at two ends of the terminal subassembly 820, respectively. The second signal mating ends may extend into the front opening 713 of the front portion 710. When the cable connector 100 is connected to the board connector 600, the front portion 201 of the cable connector 100 may be inserted into the front opening 713, and the second signal mating ends may be inserted into the subassembly chamber 212 of the front portion 201 to electrically contact a terminal subassembly 320, thereby enabling the cable connector 100 to be electrically connected to the board connector 600. In this way, high-speed signals can be transmitted between the cable connector 100 and the board connector 600. The second signal tail ends of the terminal subassembly 820 may extend beyond the rear portion 720. The second signal tail ends may be mounted to the circuit board 920 by technologies such as Surface Mounted Technology (SMT) and/or Through-Hole Technology (THT), thereby achieving an electrical connection to the circuits of the circuit board 920. Depending on the mounting technology, the second signal tail ends may be configured as pins, SMT tails, or press-mounting tails and so on. Optionally, signal through holes 922 are provided in the circuit board 920, as shown in FIG. 22a. The arrangement pattern of the signal through holes 922 may correspond to that of the second signal tail ends of the board connector 600 to be connected. Optionally, a sidewall of each signal through hole 922 may be plated with a metal conductive layer. The second signal tail ends may be inserted into corresponding signal through holes to electrically contact the metal conductive layers. The metal conductive layers of these signal through holes 922 can be electrically connected to different conductive traces within the circuit board 920 to form the desired circuitry. In this way, the board connector 600 and the circuit board 920 can be interconnected, for transmitting high-speed signals.

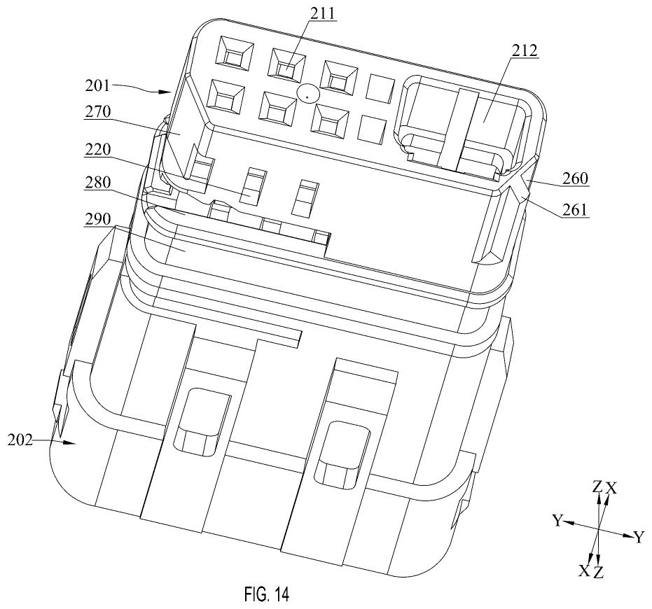

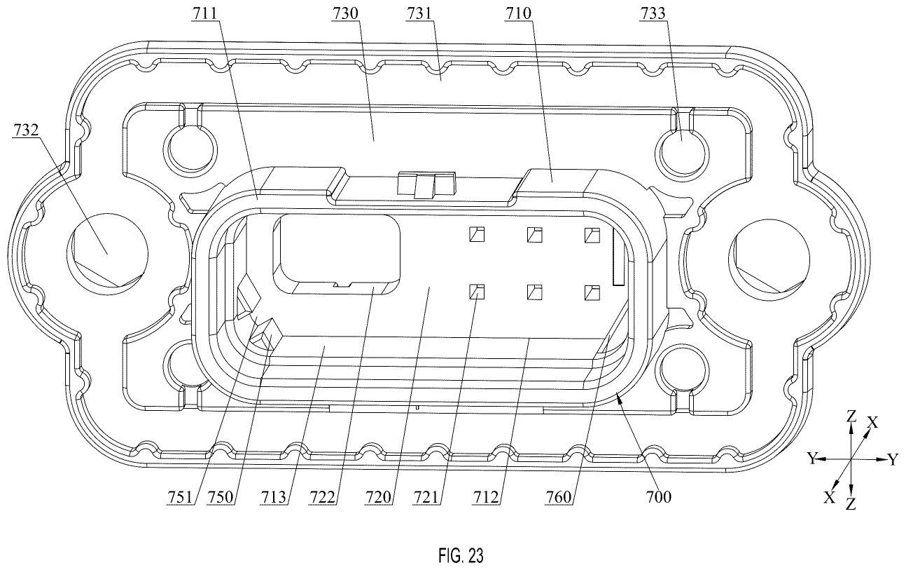

Exemplarily, as shown in FIG. 14, the front portion 201 has an asymmetric contour in a lateral plane perpendicular to the mating direction X-X. In the illustrated embodiment, the contour of the front portion 201 is asymmetrical relative to a centerline parallel to the second lateral direction Z-Z in the lateral plane. Correspondingly, the inner sidewall of the front opening 713 of the front portion 710 of the board connector 600 has a structure adapted to the contour of the front portion 201, as shown in FIGS. 22b and 23. With this configuration, the relevant person can recognize the mounting direction of the front portion 201 to the front opening 713 of the board connector 600 by observation with naked eyes or detection by a detector or the like. As a result, it can have a better dummy-proof effect.

Exemplarily, as shown in FIG. 14, the front portion 201 may have a first corner 260 and a second corner 270. The first corner 260 and the second corner 270 may be disposed opposite each other in the first lateral direction Y-Y. Outer surfaces of both the first corner 260 and the second corner 270 may be inclined. The inclined surface of the first corner 260 may be provided with a rib 261 extending in the mating direction X-X. With this configuration, the dummy-proof structure of the front portion 201 is more visible, thereby facilitating the observation. Moreover, the structure of the inner housing 200 is more concise and convenient for processing and manufacturing.

Correspondingly, the front portion 710 of the board connector 600 may have a structure adapted to the front portion 201. For example, as shown in FIG. 23, the front opening 713 of the front portion 710 may have a third corner 750 and a fourth corner 760. The third corner 750 and the fourth corner 760 may be disposed opposite each other in the first lateral direction Y-Y. Both the third corner 750 and the fourth corner 760 may have inclined faces. The inclined face of the third corner 750 may be provided with a break 751 extending in the mating direction X-X. With this configuration, when the cable connector 100 is connected to the board connector 600, the first corner 260 may abut against the third corner 750 and the rib 261 may be inserted into the break 751. The second corner 270 may abut against the fourth corner 760.

As shown in FIGS. 19-21, the electronic system 900 may further comprise a panel 910. The panel 910 may serve as a mounting substrate for the board connector 600, such as a shell for an electronic device interconnected by the cable connector 100 and the board connector 600. The panel 910 may be provided with an opening 911. The board connector 600 may be fixed to the panel 910 by a fastener 840. For example, the housing 700 may be fixed to the panel 910 by the fastener 840. The fastener 840 may include, but is not limited to, a screw or a rivet. The front portion 710 of the board connector 600 may extend to an outer side of the panel 910 through the opening 911. The rear portion 720 of the board connector 600 may be located on an inner side of the panel 910. Depending on the type of the board connector 600, the positional relationship between the panel 910 and the circuit board 920 may be different. In the embodiments illustrated in FIGS. 19-21 and FIG. 26, the board connectors 600 and 600′ are vertical connectors, and the panel 910 and the circuit board 920 may be parallel to each other. In the embodiments illustrated in FIGS. 27 and 28, the board connectors 600″ and 600′″ are right-angle connectors, and the panel 910 and the circuit board 920 may be perpendicular to each other.

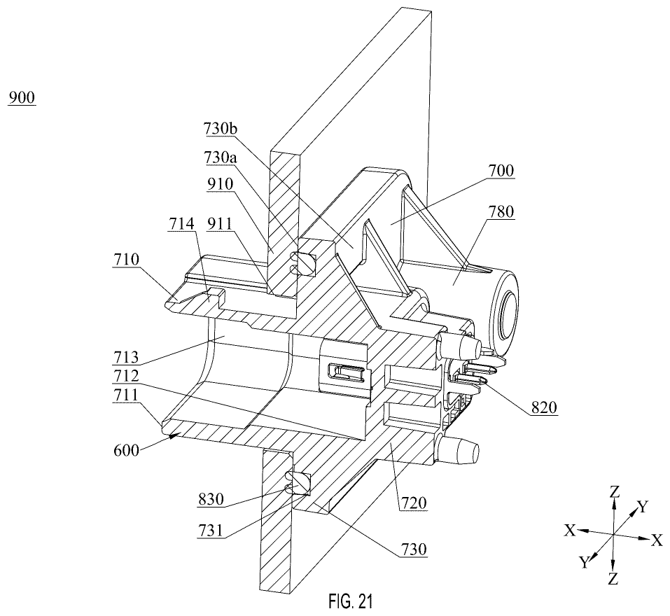

Exemplarily, as shown in FIGS. 21, 22a, 22b, and 23-24, the board connector 600 may further include a flange 730. The flange 730 extends from the outer sidewall of the housing 700 in the lateral direction. The flange 730 may be integrally formed with the housing 700 by molding. The flange 730 may be elongated, for example, it may extend only in the first lateral direction Y-Y or only in the second lateral direction Z-Z; or, the flange 730 may be L-shaped, for example, it may extend partially in the first lateral direction Y-Y and partially in the second lateral direction Z-Z; or, the flange 730 may be in a ring shape so as to surround the housing 700. The housing 700 may pass from the inner side of the panel 910 through the opening 911 until a first surface 730a of the flange 730 abuts against the inner surface of the panel 910. In this way, only the front portion 710 extends to the outer side of the panel 910. When the flange 730 abuts against the inner surface of the panel 910, the housing 700 and the panel 910 can be secured by the fastener 840, as shown in FIG. 19. Thus, the flange 730 may function as a limit, thereby facilitating the housing 700 to be in a desired fixed position. Also, the portion of the housing 700 beyond the panel 910 may have a reduced length. Exemplarily, the flange 730 may be disposed on the front portion 710 of the housing 700.

Exemplarily, as shown in FIG. 19, the fastener 840 may secure the flange 730 to the panel 910. For example, a hole 732 may be disposed in the flange 730. The fastener 840 may pass from the outer side of panel 910 through the hole 912 in the panel 910 and be fixed to the hole 732. In the illustrated example, the flange abuts against the panel 910 from the inner side, and the fastener passes through the panel hole to the flange. Such a configuration may relax tolerance requirements on the panel hole and therefore make it easier to assemble the board connector 600 with the panel 910.

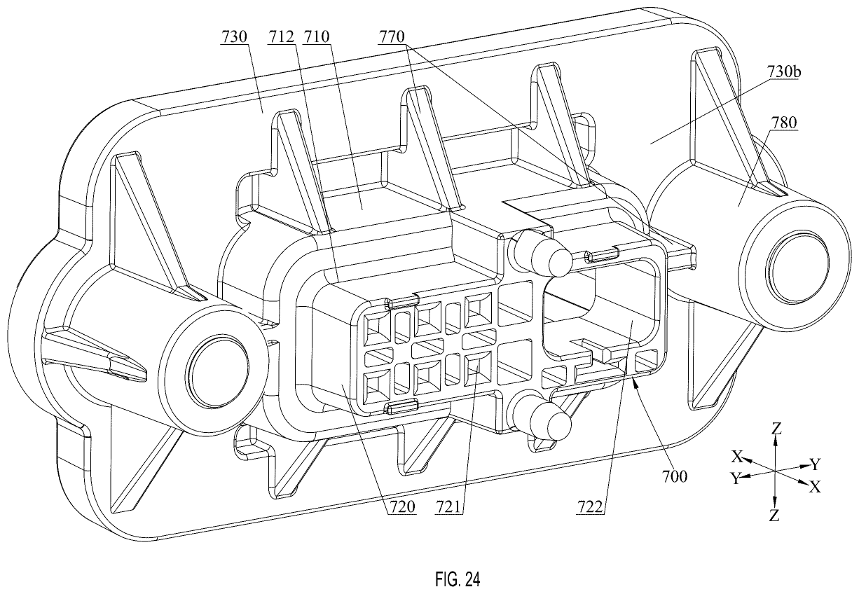

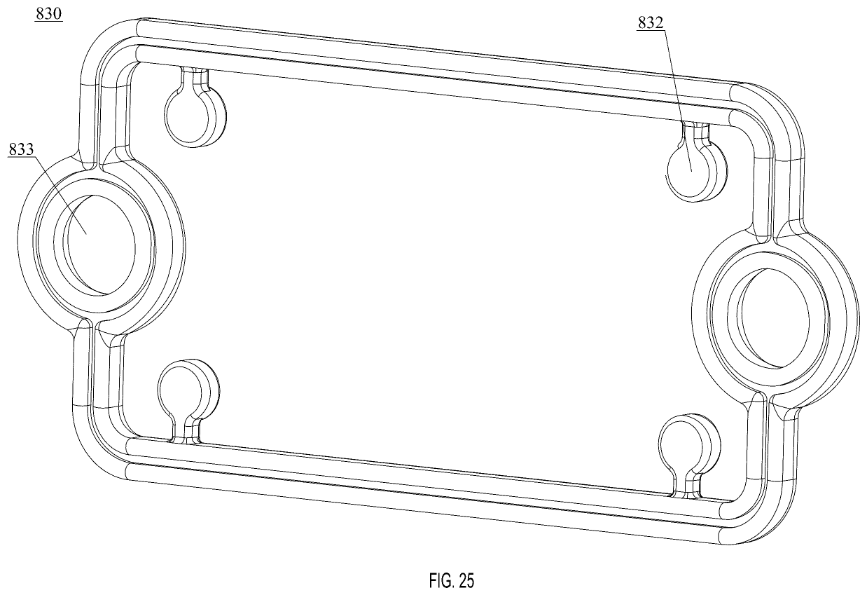

Exemplarily, the hole 732 in the flange 730 may be processed directly with internal threads, and the fastener 840 may be provided with external threads such that the fastener 840 is connected to the flange 730 and the panel 910 is clamped therebetween. Exemplarily, as shown in FIGS. 21 and 24, a second surface 730b of the flange 730 opposite the first surface 730a may be provided with a post 780 extending toward the inner side of the panel 910. The hole 732 may penetrate from the first surface 730a through the post 780. As shown in FIG. 22a, a nut 740 may be secured inside the hole 732. The fastener 840 may be a screw threaded into the nut 740. In some embodiments, the flange 730 is integrally molded with the housing 700 from an insulating material, which has a lower mechanical strength. The nut 740 may be made of a metallic material with higher mechanical strength, thereby increasing connection strength between the fastener 840 and the housing 700. Exemplarily, the nut 740 may be fixed inside the hole 732 by any suitable means, such as interference fit, bonding. Exemplarily, the nut 740 may be provided as an outer hexagonal nut, and at least a portion of the hole 732 may be in an inner hexagonal shape that matches the nut 740, thereby facilitating the fixation of the nut 740 inside the hole 732. The number of fasteners 840 may be configurable. Exemplarily, as shown in FIG. 19, there may be two fasteners 840. The two fasteners 840 may be disposed on two sides of the housing 700 in the first lateral direction Y-Y, respectively.

Exemplarily, as shown in FIG. 24, reinforcing ribs 770 are connected among the post 780, the outer side of the housing 700 and the second surface 730b of the flange 730 to increase the mechanical strength of this integrated member. The number of reinforcing ribs 770 may be configurable. When there are a plurality of reinforcement ribs 770, the plurality of reinforcing ribs 770 may be spaced apart in the circumferential direction of the housing 700. The reinforcing ribs 770 may increase the mechanical strength of the flange 730.

Exemplarily, as shown in FIGS. 22a-22b , the board connector 600 may further include a panel seal 830. The panel seal 830 may surround the housing 700. The panel seal 830 may be clamped between the housing 700 and the inner surface of the panel 910. In embodiments where the housing 700 is provided with the flange 730 on the outer sidewall, the panel seal 830 may be clamped between the flange 730 and the inner surface of the panel 910. The panel seal 830 may improve the sealing between the housing 700 and the panel 910.

Exemplarily, referring in conjunction to FIGS. 22b and 25, the panel seal 830 may be fixed to the first surface of the flange 730 facing the front end 711 in the mating direction X-X. In some embodiments, the first surface of the flange 730 may be provided with a groove 731. The groove 731 may surround the housing 700. The panel seal 830 may be fixed to the groove 731.

Exemplarily, as shown in FIGS. 22b and 25, the panel seal 830 may be provided with a hole 833. The fastener 840 may penetrate the hole 833. Accordingly, the panel seal 830 may also form a seal around the hole 912 in the panel 910 for the fastener 840 to pass through. As a result, contaminants can be prevented from entering the interior of the panel 910 through the hole 912. Furthermore, the number of parts can be reduced and the processing costs are lower by sealing the hole 912 and the opening 911 with a single panel seal 830.

Exemplarily, as shown in FIGS. 22a-22b , FIG. 23, and FIG. 25, the panel seal 830 may be provided with a tab 832 protruding in the lateral direction. The housing 700 may be provided with a recess 733. The recess 733 may be recessed from the first surface of the flange 730 facing the front end 711 in the mating direction X-X. The recess 733 may be a portion of the groove 731. The number of tabs 832 may be configurable, including, for example, four as illustrated in the drawings. The tabs 832 may be disposed in the recesses 733 in a one-to-one correspondence. The panel seal 830 can be properly positioned by mounting the tabs 832 into the recesses 733.

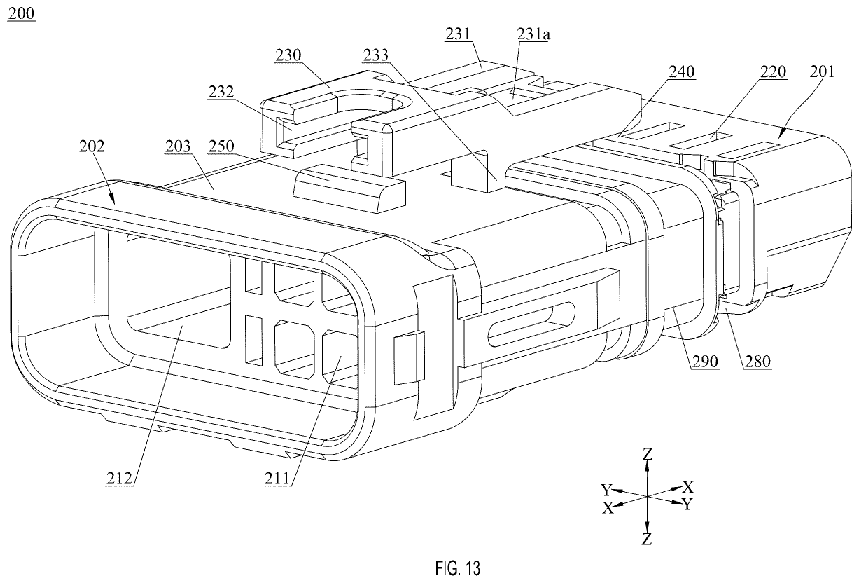

Exemplarily, as shown in FIGS. 12-13, the inner housing 200 may have an outer surface 203. A housing latch 230 may be provided on the outer surface 203. The housing latch 230 may include a cantilever 231. Exemplarily, the outer surface 203 may be the one that is wider in the lateral direction to have a large enough space for the housing latch 230. A gap 240 may be provided between the cantilever 231 and the outer surface 203. The gap 240 may be configured to receive a portion of the board connector 600 that engages with cantilever 231, such as the sidewall of the front portion 710 (as shown in FIGS. 12-13). For example, when the cable connector 100 is connected to the board connector 600, the sidewall of the front portion 710 can be inserted into the gap 240.

As shown in FIGS. 4, 6-11, and 15, the cable connector 100 may further comprise a connector position assurance (CPA) device 410. The connector position assurance device 410 is movable between a locked position and an unlocked position in the mating direction X-X. The connector position assurance device 410 may include a main body 411 and a cantilever 412. The cantilever 412 may be connected to the main body 411. FIG. 10 illustrates the connector position assurance device 410 in the locked position. In the locked position, the cantilever 412 may abut against the cantilever 231 on an outer side of the cantilever 231 opposite the gap 240. In the process of the cable connector 100 connected to the board connector 600, referring to FIG. 10, the connector position assurance device 410 may be firstly pulled away from the front portion 201 (e.g., leftward) in the mating direction X-X so that the connector position assurance device 410 is moved to the unlocked position. In the unlocked position, a bulge 415 on the cantilever 412 abuts against a stopper 235 on the housing latch 230, and the cantilever 412 fails to abut against the outer side of the cantilever 231. The front portion 201 of the inner housing 200 is then connected in place to the front portion 710 of the housing 700 such that the front portion 710 is inserted into the gap 240. Next, the connector position assurance device 410 may be pushed toward the front portion 201 to the locked position, and the cantilever 412 abuts against the outer side of the cantilever 231. In this way, the risk is reduced that the front portion 710 m be detached from the inner housing 200 due to accidental deformation of the cantilever 231.

Conversely, when it is needed to plug out the cable connector 100 from the board connector 600, the connector position assurance device 410 can be moved to the unlocked position firstly, and then the inner housing 200 is plugged out from the front portion 710.

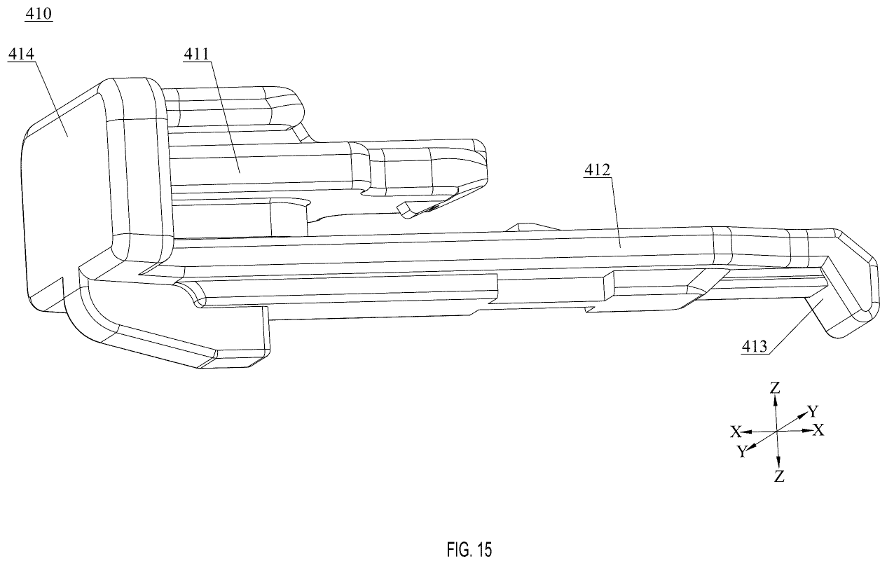

Exemplarily, as shown in FIGS. 6-11, the inner housing 200 may be provided with a supporting feature 250 on the outer surface 203. When the connector position assurance device 410 is in the locked position, the main body 411 of the connector position assurance device 410 may abut against the supporting feature 250 in a direction perpendicular to the outer surface 203 (sec, e.g., FIG. 4). In this way, the risk is reduced that the main body 411 of the connector position assurance device 410 may move toward the outer surface 203 under an external force, and thus the cantilever 412 may tilt upwardly away from the outer surface 203. Accordingly, the cantilever 231 can be abutted against by the cantilever 412 to be in a state of being engaged to the board connector 600. The cantilever 412 may further comprise a hook 413 bent toward the outer surface 203 at a front end, which, as shown in FIGS. 10 and 15, may mate with a bevel of the front end of the cantilever 231 when the connector position assurance device 410 is in the locked position. Thus, the risk is reduced that the connector position assurance device 410 may be detached from the cantilever 231 in the mating direction X-X.

The housing latch 230 is connected to the inner housing 200 at its middle by a pillar 233, whereupon an opposite end 234 of the housing latch 230 opposite the cantilever 231 is also cantilevered, as shown in FIGS. 12-13. The pillar 233 enables both ends of the housing latch 230 to be in cantilevered structure, which can be functional when the cable connector 100 is removed from the board connector 600. For example, when it is needed to release the cable connector 100 from the board connector 600, the connector position assurance device 410 is pulled out substantially to the left as shown in FIG. 10, and the main body 411 can be completely separated from the supporting feature 250 when it reaches the unlocked position, whereupon the main body 411 is spaced apart from the outer surface 203. At this point, the main body 411 may be pressed toward the outer surface 203 (e.g., downward) until it abuts against the outer surface 203. Since the housing latch 230 is supported by the pillar 233 in the middle, the cantilever 231 can be caused to turn up (e.g., upward) away from the outer surface 203 when the main body 411 is pressed. In this way, the cantilever 231 can be released from mating with a locking protrusion 714 on the front portion 710 of the board connector 600, and the cable connector 100 can be pulled out in the process.

Exemplarily, as shown in FIG. 13, the housing latch 230 may be provided with a first guiding groove 232. The first guiding groove 232 may extend in the mating direction X-X. The main body 411 of the connector position assurance device 410 is slidably connected to the first guiding groove 232. The first guiding groove 232 may serve as a guide so that the connector position assurance device 410 can be moved to a desired position.

Exemplarily, as shown in FIGS. 5-6, and 18, the cable connector 100 may further comprise an outer housing 500. The outer housing 500 may be disposed outside the inner housing 200. The outer housing 500 may provide protection to the inner housing 200 from being damaged. The outer housing 500 may be made of a material with higher mechanical strength. The outer housing 500 may comprise a protruding cover 510. The cover 510 may enclose the cantilever 231. The cover 510 may serve to protect the cantilever 231 and the connector position assurance device 410 that are locked with the board connector 600 to prevent the board connector 600 and the cable connector 100 from accidental detachment. Further, the cover 510 may prevent components such as cables from wrapping around the connector position assurance device 410 or the cantilever 231 to make them detached from the board connector 600.

Exemplarily, as shown in FIGS. 5-6 and 18, the outer housing 500 may have a front end 501 and a rear end 502. The front end 501 and the rear end 502 may be disposed opposite each other in the mating direction X-X. The front end 501 may be oriented in the same direction as the front portion 201, e.g., facing the mating ends 312 of the plurality of receptacle terminals 310. The outer housing 500 may be provided with a housing opening 520 exposing the connector position assurance device 410 and the housing latch 230. The housing opening 520 may extend to the front end 501. In this way, in the process of the cable connector 100 connected to the board connector 600, the locking protrusion 714 on the front portion 710 of the board connector 600 (shown in FIGS. 4, 21, and 22b) may slide into the housing opening 520 to mate with the cantilever 231. Exemplarily, the cantilever 231 may be provided with an aperture 231a, as shown in FIG. 13. As shown in FIG. 4, the locking protrusion 714 crosses over the front end of the cantilever 231 to enter into the aperture 231a and abuts against a sidewall of the aperture 231a when the two cable connectors are mated.

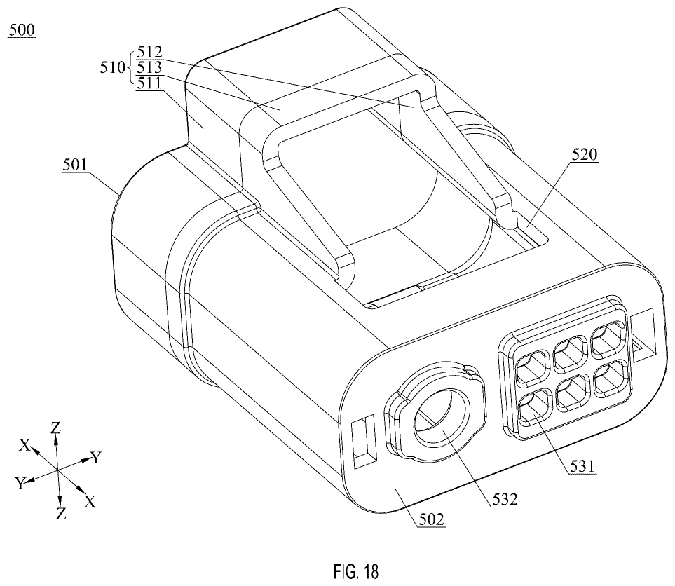

Exemplarily, as shown in FIG. 18, the cover 510 may include a first cover sidewall 511, a second cover sidewall 512 and a top wall 513. The first cover sidewall 511, the second cover sidewall 512 and the top wall 513 may be encircled to form the cover 510. The first cover sidewall 511 and the second cover sidewall 512 may extend outwardly from two sides of the housing opening 520, respectively. The two sides may be opposite each other in the first lateral direction Y-Y. The top wall 513 may be connected between the first cover sidewall 511 and the second cover sidewall 512. The top wall 513 may be adjacent to the front end 501. The first cover sidewall 511, the second cover sidewall 512 and the top wall 513 may enclose the main locking components of the cable connector 100 and the board connector 600, such as the cantilever 412 and the cantilever 231, from three sides. Exemplary, as shown in FIGS. 5-6, the cover 510 may expose the main body 411 of the connector position assurance device 410. This may allow a user to easily move the connector position assurance device 410 through the main body 411.

Exemplarily, as shown in FIG. 18, the first cover sidewall 511 and the second cover sidewall 512 extend beyond the top wall 513 in a direction from the front end 501 to the rear end 502. In this way, the first cover sidewall 511 and the second hood sidewall 512 with a greater length may act as a barrier at the supporting feature 250 to prevent cables from entering into the space between the opposing end 234 of the housing latch 230 as well as the main body 411 of the connector position assurance device 410 and the outer surface 203 of the inner housing 200. While the top wall 513 with a less length may expose the main body 411 of the connector position assurance device 410 for easy operation by the user. Exemplarily, as shown in FIG. 18, the first cover sidewall 511, the second cover sidewall 512 and the top wall 513 may extend to the front end 501. In this way, when the cable connector 100 and the board connector 600 are connected in place, as shown in FIG. 4, the panel 910 may also block the space inside the cover 510 at the end of the cover 510, to avoid the influence of foreign objects upon the locking components. Exemplarily, as shown in FIG. 5, the first cover sidewall 511 and the second cover sidewall 512 backwardly extend to an end face 414 of the main body 411 opposed to the cantilever 412. As a result, structural simplicity can be ensured while rendering maximized protection for the connector position assurance device 410 and the housing latch 230.

Exemplarily, as shown in FIGS. 5 and 18, the rear end 502 of the outer housing 500 is substantially closed and may be provided with only a plurality of third conduits 531 and a fourth conduit 532 for the first cables 350 and the second cable 360, respectively, to pass through. The first cables 350 may pass through the third conduits 531 in a one-to-one correspondence. The second cable 360 may pass through the fourth conduit 532. Thus, a sealing performance of the cable connector 100 can be improved.

### EXAMPLES

In an example, an electrical connector (e.g., 100) may comprise an inner housing (e.g., 200), a plurality of first terminals (e.g., 310) and a terminal subassembly (e.g., 320). The inner housing may have a front portion (e.g., 201) and a rear portion (e.g., 202). The inner housing may comprise a subassembly chamber (e.g., 212) and a plurality of terminal channels (e.g., 211) extending from the front portion to the rear portion. The plurality of first terminals may be disposed in the plurality of terminal channels in a one-to-one correspondence. The plurality of first terminals may be configured for transmitting power signals and/or low-speed signals. The terminal subassembly may be disposed in the subassembly chamber.

Optionally, the plurality of first terminals may be disposed in the plurality of terminal channels from the rear portion. The inner housing may be provided with a slit (e.g., 220). Each of the plurality of first terminals may be provided with a third beam (e.g., 312d) engaged with the slit. The slit may block the third beam in a direction toward the rear portion.

Optionally, there may be a plurality of the slits disposed in a one-to-one correspondence with the plurality of first terminals.

Optionally, the slit may penetrate from an inner surface to an outer surface of the inner housing.

Optionally, each of the plurality of first terminals may have a mating end (e.g., 312) configured for electrically contacting with a mating electrical connector (e.g., 600). The slit may be positioned corresponding to the mating end.

Optionally, an outer surface of the inner housing may be provided with a housing latch (e.g., 230) including a cantilever (e.g., 231). A gap (e.g., 240) may be provided between the cantilever and the outer surface of the inner housing for receiving a portion of a mating electrical connector configured to engage with the cantilever. The electrical connector may further comprise a connector position assurance device (e.g., 410). The connector position assurance device may be movably mounted to the inner housing between a locked position and an unlocked position in a mating direction (e.g., X-X) of the front portion with the mating electrical connector. The connector position assurance device may include a main body (e.g., 411) and a cantilever (e.g., 412) connected to the main body. The cantilever of the connector position assurance device may abut against the cantilever of the housing latch on an outer side of the cantilever of the housing latch opposite the gap when the connector position assurance device is in the locked position. The cantilever may release the cantilever when the connector position assurance device is in the unlocked position.

Optionally, the electrical connector may further comprise an outer housing (e.g., 500) sleeved on the inner housing. The outer housing may comprise a protruding cover (e.g., 510) configured to enclose the cantilever of the housing latch.

Optionally, the outer housing may have a front end (e.g., 501) and a rear end (e.g., 502) disposed opposite each other in the mating direction of the front portion with the mating electrical connector. The front end and the front portion may be oriented the same direction. The outer housing may have a housing opening (e.g., 520) exposing the connector position assurance device and the housing latch. The housing opening may extend to the front end. The cover may include a first cover sidewall (e.g., 511), a second cover sidewall (e.g., 512) and a top wall (e.g., 513). The first cover sidewall and the second cover sidewall may extend outwardly from two sides of the housing opening opposite each other in a first lateral direction (e.g., Y-Y) perpendicular to the mating direction, respectively. The top wall may be connected between the first cover sidewall and the second cover sidewall.

Optionally, the main body may be exposed by the cover and the cantilever of the housing latch may be shielded by the cover.

Optionally, the first cover sidewall and the second cover sidewall may extend from the top wall in a direction from the front end to the rear end.

Optionally, the top wall, the first cover sidewall and the second cover sidewall may extend to the front end.

Optionally, the first cover sidewall and the second cover sidewall may extend to an end face of the main body opposed to the cantilever of the housing latch.

Optionally, the outer surface of the inner housing may be provided with a supporting feature (e.g., 250). The main body of the connector position assurance device may abut against the supporting feature in a direction perpendicular to the outer surface when the connector position assurance device is in the locked position.

Optionally, the housing latch may be provided with a first guiding groove (e.g., 232) extending in the mating direction. The main body of the connector position assurance device may be slidably connected to the first guiding groove.

Optionally, the front portion may have an asymmetric contour in a lateral plane perpendicular to a mating direction of the front portion with a mating electrical connector.

Optionally, the front portion may have a first corner (e.g., 260) and a second corner (e.g., 270) disposed opposite each other in a first lateral direction perpendicular to the mating direction. Outer surfaces of the first corner and the second corner both may be inclined. The outer surface of the first corner may be provided with a rib (e.g., 261) extending in the mating direction.

Optionally, the electrical connector may further comprise a terminal position assurance device (e.g., 420) mounted to the inner housing in a first lateral direction perpendicular to a mating direction of the front portion with a mating electrical connector. The terminal position assurance device may be configured for assuring the position of the plurality of first terminals in the mating direction.

Optionally, the plurality of first terminals may be arranged in two rows spaced apart from each other in a second lateral direction (e.g., Z-Z) perpendicular to the first lateral direction and the mating direction.

Optionally, the terminal position assurance device may include a first arm (e.g., 431) and a second arm (e.g., 432). The first arm and the second arm may be connected with each other such that the terminal position assurance device is U-shaped. The first arm and the second arm may lock the two rows, respectively.

Optionally, the inner housing may be provided with a locking slot (e.g., 280) extending in the first lateral direction. The locking slot may have a first locking slot sidewall (e.g., 281) and a second locking slot sidewall (e.g., 282) disposed opposite each other in the mating direction. The first locking slot sidewall may be provided with a second guiding groove (e.g., 283). The second locking slot sidewall may be provided with a notch (e.g., 284). The terminal position assurance device may have a first side (e.g., 421) and a second side (e.g., 422) disposed opposite each other in the mating direction. The first side may be provided with a guiding feature (e.g., 440) inserted into the second guiding groove. The second side may be provided with a barb (e.g., 460) engaged with the notch.

Optionally, the terminal position assurance device may be provided with a slit (e.g., 423) extending in the first lateral direction. A distance from the slit to the first side may be greater than a distance to the second side. The barb may be at a position corresponding to a middle of the slit.

Optionally, the terminal position assurance device may include a body (e.g., 460) having an inner surface (e.g., 461) facing an interior of the inner housing. The inner surface may be provided with a projection (e.g., 470) extending in the first lateral direction. The projection may block the plurality of first terminals in a direction toward the rear portion.

Optionally, the body may span the plurality of first terminals in the first lateral direction. The projection may extend from the body in the first lateral direction and a protruding end (e.g., 471) of the projection may extend into the inner housing.

Optionally, the terminal position assurance device may have a first side (e.g., 421) and a second side (e.g., 422) disposed opposite each other in the mating direction. The projection may be flush with the body at the first side. The inner housing may be provided with a guiding groove (e.g., 283) extending in the first lateral direction. The first side may be provided with a guiding feature (e.g., 440) inserted in the guiding groove.

Optionally, the guiding feature may be flush with an inner surface (e.g., 472) of the projection. The guiding feature may be spaced apart from an outer surface of the body.

Optionally, the front portion of the inner housing may be provided with an annular recess (e.g., 290) on an outer surface thereof. The annular recess may encircle the front portion in a circumferential direction perpendicular to a mating direction of the front portion with a mating electrical connector. The annular recess may be configured to receive a mating end seal (e.g., 330) configured for sealing between the front portion and the mating electrical connector.

Optionally, the electrical connector may further comprise a tail end seal (e.g., 340) disposed in the rear portion of the inner housing. A first cable (e.g., 350) terminated to the terminal subassembly and second cables (e.g., 360) terminated to the plurality of first terminals may pass through the tail end seal.

In another example, a cable connector may comprise an inner housing, a plurality of first terminals and a position assurance feature. The inner housing may have a front portion and a rear portion. The inner housing may comprise a plurality of terminal channels extending from the front portion to the rear portion. The plurality of first terminals may be disposed in the plurality of terminal channels in a one-to-one correspondence. The plurality of first terminals may be configured for transmitting power signals and/or low-speed signals. The position assurance feature may be configured to restrain the movement of the plurality of first terminals in a mating direction of the front portion with a mating electrical connector.

Optionally, the plurality of first terminals may be disposed in the plurality of terminal channels from the rear portion. Each of the plurality of first terminals may have a mating end for electrically contacting with the mating electrical connector. The mating end may abut against the front portion of the inner housing. The position assurance feature may be configured to restrain the plurality of first terminals in a direction toward the rear portion.

Optionally, the position assurance feature may include a slit disposed in the inner housing. Each of the plurality of first terminals may be provided with a third beam engaged with the slit.

Optionally, the slit may penetrate an inner surface of the inner housing to an outer surface. Optionally, there may be a plurality of the slits disposed in a one-to-one correspondence with the plurality of first terminals. Optionally, the slit may correspond to the mating end in position.

Optionally, the position assurance feature may include a terminal position assurance device mounted to the inner housing in a first lateral direction perpendicular to the mating direction.

Optionally, the plurality of first terminals may be arranged in two rows spaced apart from each other in a second lateral direction perpendicular to the first lateral direction and the mating direction.

Optionally, the terminal position assurance device may include a first arm and a second arm. The first arm and the second arm may be connected to each other such that the terminal position assurance device is U-shaped. The first arm and the second arm may lock the two rows, respectively.

Optionally, the inner housing may be provided with a locking slot extending in the first lateral direction. The locking slot may have a first locking slot sidewall and a second locking slot sidewall opposite each other in the mating direction. The first locking slot sidewall may be provided with a guiding groove. The second locking slot sidewall may be provided with a notch. The terminal position assurance device may have a first side and a second side disposed opposite each other in the mating direction. The first side may be provided with a guiding feature inserted into the guiding groove. The second side may be provided with a barb engaged with the notch.

Optionally, the terminal position assurance device may include a body having an inner surface facing an interior of the inner housing. The inner surface may be provided with a projection extending in the first lateral direction. The projection may block the plurality of first terminals in a direction toward the rear portion.

Optionally, the body may span the plurality of first terminals in the first lateral direction. The projection may extend from the body in the first lateral direction. A protruding end of projection may extend into the inner housing.

Optionally, the terminal position assurance device may have a first side and a second side disposed opposite each other in the mating direction. The projection may be flush with the body at the first side. The inner housing may be provided with a guiding groove extending in the first lateral direction. The first side may be provided with a guiding feature inserted in the guiding groove.

Optionally, the guiding feature may be flush with an inner surface of the projection, and be spaced apart from an outer surface of the body.

In another example, a board connector (e.g., 600) may comprise a housing (e.g., 700), a plurality of second terminals (e.g., 810) and a terminal subassembly (e.g., 820). The housing may include a front portion (e.g., 710) and a rear portion (e.g., 720). The front portion may have a front end (e.g., 711) and a rear end (e.g., 712) disposed opposite each other in a mating direction. The front portion may be provided with a single front opening (e.g., 713). The front opening may extend from the front end to the rear end. The rear portion may be connected to the rear end. The rear portion may have a subassembly chamber (e.g., 722) and a plurality of terminal channels (e.g., 721) aligned with the front opening. The plurality of second terminals may be disposed in the plurality of terminal channels in a one-to-one correspondence. The terminal subassembly may be disposed in the subassembly chamber.

Optionally, the board connector may further comprise a flange (e.g., 730) protruding from an outer sidewall of the rear portion in a lateral direction. The flange may be provided with a hole (e.g., 732).

Optionally, the board connector may further comprise a panel seal (e.g., 830) encircling the front portion. The panel seal may be fixed to a surface of the flange facing the mating end in the mating direction.

Optionally, the panel seal may be provided with a tab (e.g., 832) protruding in a lateral direction. The flange may be provided with a recess (e.g., 733), and the tab may be disposed in the recess.

In another example, an electronic system (e.g., 900) may comprise a board connector and a panel (e.g., 910). The panel may be provided with an opening (e.g., 911). The board connector may be fixed to the panel by a fastener (e.g., 840). The board connector may comprise a housing, a plurality of second terminals and a terminal subassembly. A front portion of the housing may extend to an outer side of the panel through the opening. The housing may have a plurality of terminal channels and a subassembly chamber. The plurality of second terminals may be disposed in the plurality of terminal channels in a one-to-one correspondence and extend into the front portion. The terminal subassembly may be mounted to the subassembly chamber and extend into the front portion.

Optionally, the board connector may further comprise a flange protruding in a lateral direction from an outer sidewall of the housing. A first surface of the flange may abut against an inner surface of the panel.

Optionally, the fastener may secure the flange to the panel.

Optionally, a second surface of the flange opposite the first surface may be provided with a post (e.g., 780) extending toward an inner side of the panel. The post may be provided with a hole penetrating to the first surface. The hole may be accommodated with a nut connected with the fastener.

Optionally, a reinforcing rib (e.g., 770) may be connected among the post, the outer sidewall of the housing and the flange.

Optionally, the board connector may further comprise a panel seal encircling the housing and clamped between the housing and the inner surface of the panel.

Optionally, the panel seal may be provided with a hole with the fastener passing therethrough.

Optionally, the panel seal may be provided with a tab protruding in a lateral direction. The housing may be provided with a recess, and the tab may be disposed in the recess.

The present disclosure has been described by the above embodiments, but it should be understood that a variety of variations, modifications and improvements may be made according to the teaching of the present disclosure by those skilled in the art, and all of these variations, modifications and improvements fall within the spirit and the scope of protection of the present disclosure. The scope of protection of the present disclosure is defined by the appended claims and its equivalent scope. The above embodiments are only for the purpose of illustration and description, and are not intended to limit the present disclosure to the scope of the described embodiments.

Moreover, although many creative aspects of the electronic system have been described above with reference to a board connector and a cable connector, it should be understood that the aspects of the present disclosure are not limited to these. Any one of the creative features, whether alone or combined with one or more other creative features, can also be used for two mated cable connectors or two mated board connectors. Also, the board connector can be a plug connector or a receptacle connector. The board connector may be an orthogonal connector, a vertical connector, a coplanar connector, or a right-angle connector.

In the description of the present disclosure, it is to be understood that orientation or positional relationships indicated by orientation words “front', “rear”, “upper”, “lower”, “left”, “right”, “lateral direction”, “mating direction”, “perpendicular direction”, “perpendicular”, “horizontal”, “top”, “bottom” and the like usually are shown based on the accompanying drawings, only for the purposes of the case in describing the present disclosure and simplification of its descriptions. Unless stated to the contrary, these orientation words do not indicate or imply that the specified apparatus or element has to be specifically located, and structured and operated in a specific direction, and therefore, should not be understood as limitations to the present disclosure. The orientation words “inside” and “outside” refer to the inside and outside relative to the contour of each component itself.

For facilitating description, the spatial relative terms such as “on”, “above”, “on an upper surface of” and “upper” may be used here to describe a spatial position relationship between one or more components or features and other components or features shown in the accompanying drawings. It should be understood that the spatial relative terms not only include the orientations of the components shown in the accompanying drawings, but also include different orientations in use or operation. For example, if the component in the accompanying drawings is turned upside down completely, the component “above other components or features” or “on other components or features” will include the case where the component is “below other components or features” or “under other components or features”. Thus, the exemplary term “above” can encompass both the orientations of “above” and “below”. In addition, these components or features may be otherwise oriented (for example rotated by 90 degrees or other angles) and the present disclosure is intended to include all these cases.

It should be noted that the terms used herein are only for describing specific embodiments, and are not intended to limit the exemplary embodiments according to the present application. As used herein, an expression of a singular form includes an expression of a plural form unless otherwise indicated. In addition, it should also be understood that when the terms “including” and/or “comprising” are used herein, it indicates the presence of features, steps, operations, parts, components and/or combinations thereof.

It should be noted that the terms “first”, “second” and the like in the description and claims, as well as the above accompanying drawings, of the present disclosure are used to distinguish similar objects, but not necessarily used to describe a specific order or precedence order. It should be understood that ordinal numbers used in this way can be interchanged as appropriate, so that the embodiments of the present disclosure described herein can be implemented in a sequence other than those illustrated or described herein.

1. An electrical connector, comprising:
a housing comprising a front portion, a rear portion, a subassembly chamber, and a plurality of terminal channels;
a terminal subassembly disposed in the subassembly chamber, the terminal subassembly comprising a pair of terminals configured for transmitting high-speed signals; and
a plurality of terminals, each of the plurality of terminals disposed in one of the plurality of terminal channels, the plurality of terminals configured for transmitting power signals and/or low-speed signals.

2. The electrical connector of claim 1, wherein:
both the subassembly chamber and the plurality of terminal channels extend from the front portion to the rear portion; and
each of the plurality of terminals comprises a beam configured to extend into a top wall of the front portion of the housing so as to restrain movements of the terminal.

3. The electrical connector of claim 1, wherein:
the housing comprises a latch having a cantilever, and a supporting feature protruding from an outer surface;
the electrical connector further comprises a connector position assurance device, the connector position assurance device is movably mounted to the latch of the housing between a locked position and an unlocked position; and
the connector position assurance device comprises a main body configured to be disposed above the supporting feature when the connector position assurance device is in the locked position, and a cantilever extending from the main body and configured to abut against an outer side of the cantilever of the latch of the housing when the connector position assurance device is in the locked position.

4. The electrical connector of claim 3, wherein:
the housing is an inner housing; and
the electrical connector further comprises an outer housing disposed outside the inner housing and comprising a cover protruding above the cantilever of the latch of the inner housing.

5. The electrical connector of claim 1, wherein:
the front portion of the housing has an asymmetric contour in a lateral plane perpendicular to a mating direction.

6. The electrical connector of claim 1, wherein:
the plurality of terminals are arranged in a plurality of rows; and
the electrical connector further comprises a terminal position assurance device configured to restrain movements of the plurality of terminals.

7. The electrical connector of claim 1, wherein:
the front portion of the housing comprises an annular recess encircling the front portion in a circumferential direction perpendicular to a mating direction; and
the electrical connector comprises a mating end seal disposed in the annular recess, and a tail end seal disposed in the rear portion of the housing and configured for cables passing therethrough.

8. The electrical connector of claim 1, wherein:
the front portion of the housing comprises a front end, a rear end disposed opposite each other in a mating direction, and a single front opening extending from the front end to the rear end; and
the rear portion of the housing is connected to the rear end of the front portion of the housing, the rear portion comprising the subassembly chamber and the plurality of terminal channels.

9. The electrical connector of claim 8, wherein:
the rear portion of the housing comprises a flange protruding from an outer sidewall, and a surface facing the front portion of the housing and a recess from the surface; and
the electrical connector further comprises a panel seal disposed on the flange and having a tab disposed in the recess.

10. An electrical connector, comprising:
a housing comprising a front portion, a rear portion, and a plurality of terminal channels extending from the front portion to the rear portion;
a plurality of terminals, each of the plurality of terminals disposed in one of the plurality of terminal channels and comprising a mating end disposed in the front portion of the housing and a tail end disposed in the rear portion of the housing, wherein:
the front portion of the housing comprises one or more position assurance features configured to restrain movements of each of the plurality of terminals in the respective terminal channel.

11. The electrical connector of claim 10, wherein:
the one or more position assurance features comprise a plurality of slits extending through an inner surface of the housing to an outer surface of the housing;
the plurality of slits are disposed in a one-to-one correspondence with the plurality of terminals; and
the mating end of each of the plurality of terminals comprises a beam extending into a respective slit of the plurality of slits.

12. The electrical connector of claim 10, wherein:
the housing comprises a locking slot extending in a first lateral direction perpendicular to a mating direction of the electrical connector;
the one or more position assurance features comprise the locking slot and a terminal position assurance device;
the locking slot comprises a first locking slot sidewall and a second locking slot sidewall opposite each other in the mating direction, the first locking slot sidewall comprising a guiding groove, and the second locking slot sidewall comprising a notch; and
the terminal position assurance device comprises a first side and a second side opposite each other in the mating direction, the first side comprising a guiding feature inserted into the guiding groove of the locking slot, and the second side comprising a barb engaged with the notch of the locking slot.

13. The electrical connector of claim 12, wherein:
the terminal position assurance device is configured to mounted into the locking slot of the housing in the first lateral direction.

14. The electrical connector of claim 12, wherein:
the plurality of terminals are arranged in two rows spaced apart from each other in a second lateral direction perpendicular to the first lateral direction and the mating direction;
the terminal position assurance device comprises a first arm and a second arm connected to the first arm; and
the first and second arms of the terminal position assurance device are configured to restrain movements of the terminals in the two rows, respectively.

15. The electrical connector of claim 12, wherein:
the terminal position assurance device comprises a body having an inner surface, a projection extending from the inner surface and configured to restrain movements of the plurality of terminals in the mating direction.

16. The electrical connector of claim 12, further comprising:
a seal disposed closer to the front portion of the housing than the rear portion of the housing and encircling the front portion of the housing in a circumferential direction perpendicular to the mating direction.

17. An electronic system, comprising:
a panel comprising an opening; and
an electrical connector comprising:
a housing comprising a front portion extending through the opening to an outer side of the panel, and a rear portion connected to the front portion and disposed on an inner side of the panel, the rear portion of the housing comprising a flange protruding from an outer sidewall and having a surface facing the panel, and
a seal disposed between the panel and the surface of the flange facing the panel.

18. The electronic system of claim 17, wherein:
the rear portion of the housing comprises a subassembly chamber configured to receive a terminal subassembly, and a plurality of terminal channels each configured to receive a terminal.

19. The electronic system of claim 18, wherein:
the flange opposite comprises a post extending toward the inner side of the panel; and
the post comprises a hole extending to the surface facing the panel and configured to receive a fastener for securing the flange to the panel.

20. The electronic system of claim 19, wherein:
the rear portion of the housing comprises a plurality of recesses; and
the seal comprises a plurality of tabs protruding inwardly and disposed in a respective one of the plurality of recesses.
